(19) United States
(12) Patent Application Publication
(10) Pub. No.: US 2009/0116118 A1
(43) Pub. Date: May 7, 2009

(54) LENS

(75) Inventors: James Albert Frazier, New South Wales (AU); Peter Denison Parks, Oxfordshire (GB)

Correspondence Address: OPTICUS IP LAW, PLLC, 7791 ALISTER MACKENZIE DRIVE, SARASOTA, FL, 34240, US

(73) Assignee: GLOBAL BIONIC OPTICS PTY LTD, Randwick ,New South Wales (AU)

(21) Appl. No.: 11/993,504

(22) PCT Filed: Jun. 20, 2006
(86) PCT No.: PCT/AU2006/000858

§ 371 Date: Mar. 12, 2008

Related U.S. Application Data
(60) Provisional application No. 60/692,486, filed on Jun. 21, 2005.

(30) Foreign Application Priority Data
Jun. 29, 2005 (GB) 0513347.5

(51) Int. Cl. G02B 1/06; G03B 13/18

(52) U.S. Cl. 359/666; 359/665; 396/89

(57) ABSTRACT

Lenses comprising first and second walls defining a cavity therebetween, which contains a fluid, are described. At least one of the walls is flexible, and the amount of fluid in the cavity can be changed to alter the shape of the at least one flexible wall, so as to alter the power of the lens. One or more flexible walls may have at least one groove formed in the wall(s) close to the periphery(ies) of the wall(s). In yet another configuration, the flexible wall and the second wall are bonded, welded, or fused together. In yet another configuration, a lens comprises a flexible wall and a second wall. The flexible wall is resilient and thinner in its central region, which is capable of being displaced relative to the second wall. Also described are methods of manufacturing a flexible wall for a lens.

### RELATED PATENT APPLICATIONS

This patent application claims the benefit of, and is entitled to, the earlier filing dates of U.S. Provisional Patent Application No. 60/692,486 filed on 21 Jun. 2005 in the name of James Albert Frazier et al and United Kingdom Patent Application No. 0513347.5 filed on 29 Jun. 2005 in the names of Global Bionic Optics Pty Ltd and entitled “Lens”, each of which is incorporated herein by reference.

### TECHNICAL FIELD

The present invention relates to lenses and in particular inflatable lenses.

### BACKGROUND

Inflatable lenses are useful, because such lenses have variable focal lengths. These lenses can also be used as zoom lenses.

U.S. Pat. No. 5,684,637 issued on Nov. 4, 1997 to Floyd discloses an inflatable lens comprising two flexible membranes defining a cavity and retained by their edges. The cavity between the membranes is filled with a fluid. The lens is also provided with a port through which the fluid can be forced into the cavity or be removed from the cavity.

German Patent Publication No. DE 3630700 A1 published on 17 Mar. 1988 to Siemens AG discloses an inflatable lens that comprises a fluid, transparent optical medium, which is bounded by two refractive faces. At least one of the two faces is formed from a flexible, transparent film. By changing the volume of fluid between the two faces, the shape of the flexible film can be altered and the focal length of the lens can be varied.

A problem with such inflatable lenses is that the curve formed by the flexible membrane or film is not consistent across the whole area of the membrane. Because the edge of the flexible membrane must be clamped in a housing, the curve of the lens close to the edge of the membrane is not the same as that in the centre of the membrane. Consequently, the effective usable aperture of the lenses is significantly less than the actual size of the flexible membrane.

Furthermore, inflatable lenses are also affected by gravity since the fluid tends to flow to the lowest part of the lens and consequently causes bulging towards the lowest part of the lens. Such bulging results in an inconsistent curvature across the whole area of the lens.

Japanese Patent Application Publication No. 10-206609 published on 7 Aug. 1998 for Japanese Patent Application No. 9-20932 filed on 21 Jan. 1997 describes a lens that provides refractive power by deforming the shape of a flexible capsule that forms a lens. FIG. 16A illustrates the lens 1610 comprising an inlet, which is in the form of a bellows-form tank with a presser (not shown), to allow fluid to flow into the capsule. The capsule thickness decreases towards the center of the capsule. In particular, the capsule has a periphery in the form of bellows, or a concertina-like structure, 1610. This bellows structure 1610 on the periphery allows the capsule to extend or displace laterally seeking to freely deform the shape of the lens 1610. However, as shown in FIG. 16B, this results in deformation 1610′ of the lens shape 1610 in a manner that is undesirable.

A need therefore exists for improved inflatable lenses.

### SUMMARY

In accordance with an aspect of the invention, there is provided a lens comprising a first flexible wall that becomes progressively thinner towards its central region, and a second wall, the first wall and the second wall defining a cavity for receiving fluid such that various lens shapes can be formed by controlling the volume of fluid within the cavity.

In accordance with another aspect of the invention, there is provided a lens comprising a first flexible wall having a first groove formed therein towards a perimeter of the first wall for a hinge, and a second wall, the first wall and the second wall defining a cavity for receiving fluid such that various lens shapes can be formed by controlling the volume of fluid within the cavity.

The first wall may be defined by a first surface and a second surface, and the groove may be formed in the first surface of the first wall.

The first surface of the first wall may be a concave surface and the second surface of the first wall may be a planar surface. The first surface and second surface of the first wall may be concave surfaces.

The lens may further comprise a second groove towards the perimeter of the first wall, the second groove being formed in the second surface of the first wall.

The first groove may have a v-shaped cross-section, or a c-shaped cross-section.

The groove may be annular.

The first wall may become progressively thinner towards its central region and the depth of the groove may be such that the least distance between an apex or base of the groove and the second surface is substantially the same as the thickness of the first wall at its central region.

The first wall and the second wall may be housed in a barrel mounting. The first wall and the second wall may be bonded, welded or fused together.

In accordance with still another aspect of the invention, there is provided a lens comprising a first flexible wall, and a second wall, the first wall and the second wall being bonded, welded or fused together, the first wall and the second wall defining a cavity for receiving fluid such that various lens shapes can be formed by controlling the volume of fluid within the cavity.

The first wall and second wall may be bonded together using a flowable fluid silicone rubber compound. The flowable fluid silicone rubber compound may comprise triacetoxy(ethyl)silane or methyl triacetoxy(ethyl)silane.

In any of the foregoing aspects, the second wall may be formed from a rigid material and may be defined by a first surface and a second surface, wherein at least one of the first and second surfaces is a concave surface.

The second wall may be formed from a rigid material and may be defined by a first surface and a second surface, wherein at least one of the first and second surfaces is a convex surface.

The second wall may be formed from a rigid material and may be defined by a first surface and a second surface substantially parallel to the first surface.

The second wall may be formed from polycarbonate or glass. Alternatively, the second wall may be flexible. Further, the second wall may become progressively thinner towards its central region.

The lens may further comprise at least one port into the cavity through which fluid can flow. The lens may comprise a plurality of ports into the cavity through which fluid can flow, wherein the plurality of ports are spaced around a circumference of the lens. The plurality of ports may be equally spaced around the circumference of the lens. Fluid may flow both into and out of the cavity through the at least one port. The at least one port may be formed through the second wall. The at least one port may comprise a tube bonded to the second wall. The tube may comprise a polythene or silicone tube.

The fluid may comprise one of an oil, a glycerine, and a water based product. Each flexible wall may be resilient.

Each flexible wall may be formed of a component comprising a stretchable, pliable, variform disc of synthetic homogenous material of optical clarity that is capable of variable dilatation.

Each flexible wall may be formed from one of a silicone rubber, a plastics material, an acrylic material, a flexible polycarbonate, an epoxy resin and a polyester.

The lens may further comprise a fluid reservoir in fluid communication with the cavity. The lens may form a closed circuit, discreet, sealed package in which the reservoir and cavity are permanently connected via at least one port or a continuous circular channel formed by a groove.

The lens may further comprise a pump, a piston, a plunger, a conventional focus barrel, or any force-provider applied to the outside of the reservoir, for expelling fluid from the reservoir or withdrawing fluid from the lens cavity.

In accordance with a further aspect of the invention, there is provided a camera comprising a lens. The lens comprises a first flexible wall that becomes progressively thinner towards its central region; and a second wall, the first wall and the second wall defining a cavity for receiving fluid such that various lens shapes can be formed by controlling the volume of fluid within the cavity.

In accordance with another aspect of the invention, there is provided a camera comprising a lens. The lens comprises: a first flexible wall having a first groove formed therein towards a perimeter of the first wall for a hinge; and a second wall, the first wall and the second wall defining a cavity for receiving fluid such that various lens shapes can be formed by controlling the volume of fluid within the cavity.

In accordance with yet another aspect of the invention, there is provided a camera comprising a lens. The lens comprises: a first flexible wall; and a second wall, the first wail and the second wall being bonded, welded or fused together, the first wall and the second wall defining a cavity for receiving fluid such that various lens shapes can be formed by controlling the volume of fluid within the cavity.

In accordance with still another aspect of the invention, there is provided a lighting system comprising a lighting element, and a lens. The lens comprises: a first flexible wall that becomes progressively thinner towards its central region; and a second wall, the first wall and the second wall defining a cavity for receiving fluid such that various lens shapes can be formed by controlling the volume of fluid within the cavity.

In accordance with a further aspect of the invention, there is provided a lighting system comprising: a lighting element, and a lens. The lens comprises: a first flexible wall having a first groove formed therein towards a perimeter of the first wall for a hinge; and a second wall, the first wall and the second wall defining a cavity for receiving fluid such that various lens shapes can be formed by controlling the volume of fluid within the cavity.

In accordance with another aspect of the invention, there is provided a lighting system comprising: a lighting element, and a lens. The lens comprises: a first flexible wall; and a second wall, the first wall and the second wall being bonded, welded or fused together, the first wall and the second wall defining a cavity for receiving fluid such that various lens shapes can be formed by controlling the volume of fluid within the cavity.

In accordance with a further aspect of the invention, there is provided a method of manufacturing a flexible wall for a lens that becomes progressively thinner towards its central region, the flexible wall for at least partly defining a cavity for receiving fluid such that various lens shapes can be formed by controlling the volume of fluid within the cavity. The method comprises the step of moulding the flexible wall against a female profile glass, acrylic or silica optics, or plastics mould.

In accordance with a further aspect of the invention, there is provided a method of manufacturing a flexible wall for a lens having a first groove formed therein towards a perimeter of the flexible wall for a hinge, the flexible wall for at least partly defining a cavity for receiving fluid such that various lens shapes can be formed by controlling the volume of fluid within the cavity. The method comprises the step of moulding the flexible wall against a female profile glass, acrylic or silica optics, or plastics mould.

In accordance with an aspect of the invention, there is provided a method of manufacturing a flexible wall for a lens, the flexible wall for at least partly defining a cavity for receiving fluid such that various lens shapes can be formed by controlling the volume of fluid within the cavity. The method comprises the steps of: moulding the flexible wall against a female profile glass, acrylic or silica optics, or plastics mould; and bonding, welding or fusing the flexible wall together with another wall for defining the cavity.

In accordance with a further aspect of the invention, there is provided a method of manufacturing a flexible wall for a lens that becomes progressively thinner towards its central region, the first wall for at least partly defining a cavity for receiving fluid such that various lens shapes can be formed by controlling the volume of fluid within the cavity. The method comprises the step of spinning, centrifuging, introducing gas, bubble or using flow, pour, draw vacuum technology.

In accordance with another aspect of the invention, there is provided a method of manufacturing a flexible wall for a lens having a first groove formed therein towards a perimeter of the flexible wall for a hinge, the flexible wall for at least partly defining a cavity for receiving fluid such that various lens shapes can be formed by controlling the volume of fluid within the cavity. The method comprises the step of spinning, centrifuging, introducing gas, bubble or using flow, pour, draw vacuum technology.

In accordance with a still further aspect of the invention, there is provided a method of manufacturing a flexible wall for a lens, the flexible wall for at least partly defining a cavity for receiving fluid such that various lens shapes can be formed by controlling the volume of fluid within the cavity. The method comprises the steps of: forming the flexible wall by spinning, centrifuging, introducing gas, bubble or using flow, pour, draw vacuum technology; and bonding, welding or fusing the flexible wall together with another wall for defining the cavity.

In accordance with a still further aspect of the invention, there is provided a lens, comprising: a first flexible wall that is resilient and thinner in the central region of the first wall; and a second wall, at least the central region of the first wall being capable of being displaced relative to the second wall.

The first and second walls may be in communication with a displacement media. The displacement media comprises a fluid. The volume of displacement media between the first and second walls is variable.

The first wall may progressively thinner in the central region of the first wall.

The various lens shapes may be formed by controlling the volume of the displacement media between the first and second walls.

The first and second walls define a cavity for receiving the displacement media.

The flexible wall may have at least one groove formed therein adjacent the periphery of the wall.

The flexible wall and the second wall may be bonded, welded or fused together for defining the cavity.

In accordance with still another aspect of the invention, there is provided a lens. The lens comprises: a flexible wall made of a material suitable for use in an optical lens that becomes progressively thinner towards its central region, the flexible wall having at least one groove formed therein towards the periphery of the flexible wall; and another wall made of a material suitable for use in an optical lens, the first wall and the second wall configured in parallel and defining a cavity for receiving fluid, various lens shapes capable of being formed by controlling the volume of fluid between the walls.

The other wall may be flexible. Further, the other flexible wall may become progressively thinner towards its central region. Alternatively, the second wall may be rigid.

The walls may be bonded, welded, or fused together at the periphery of each wall forming a seal therebetween. Alternatively, the lens may further comprise a barrel mounting housing the walls or an annular clamp holding together the walls.

The lens may comprise at least one port formed between the walls or through one of the walls for communication of fluid between the walls. The lens may further comprise a fluid reservoir coupled to the at least one port.

The lens may further comprise a fluid that is transparent to radiation being transmitted by the lens and has suitable-thermal stability.

### BRIEF DESCRIPTION OF THE DRAWINGS

A small number of embodiments of the invention are described hereinafter with reference to the drawings, in which:

FIGS. 1a to 1d are cross-sectional, side elevation views showing a lens according to an embodiment of the present invention;

FIGS. 2a and 2b are cross-sectional, side elevation views showing a lens according to another embodiment of the present invention;

FIGS. 3a to 3c are cross-sectional, side elevation views showing a lens according to yet another embodiment of the present invention;

FIGS. 4a and 4b are cross-sectional, side elevation views showing a lens according to still another embodiment of the present invention;

FIGS. 5a to 5d are cross-sectional, side elevation views showing a lens according to a still further embodiment of the present invention;

FIGS. 6a to 6d are cross-sectional, side elevation views showing a lens according to another embodiment of the present invention;

FIGS. 7a and 7b are cross-sectional, side elevation views showing a lens according to an embodiment of the present invention;

FIGS. 8a and 8b are cross-sectional, side elevation views showing a lens according to an embodiment of the present invention;

FIGS. 9a and 9b are cross-sectional, side elevation views showing a multiple-element system including two lenses;

FIGS. 10a to 10c are cross-sectional, side elevation views showing a lens according to a further embodiment of the present invention;

FIGS. 11a to 11c are a cross-sectional, front elevation view, a cross-sectional, side elevation view and a perspective view showing a lens according to still another embodiment of the present invention;

FIG. 12 is a perspective view showing a camera including a lens according to an embodiment of the present invention;

FIG. 13 is a perspective view showing a focusable lighting system including a lens according to an embodiment of the present invention;

FIGS. 14A and 14B are partial side elevation views of a flexible wall showing two configurations of grooves with which embodiments of the invention may be practiced;

FIG. 15 is a side elevation view of a lens in accordance with an embodiment of the invention in which deeper grooves displaced relative to each other are practised; and

FIGS. 16A and 16B are cross-sectional, side elevational views of an existing lens structure having a bellows or concertina like section in its periphery in initial and deformed states, respectively.

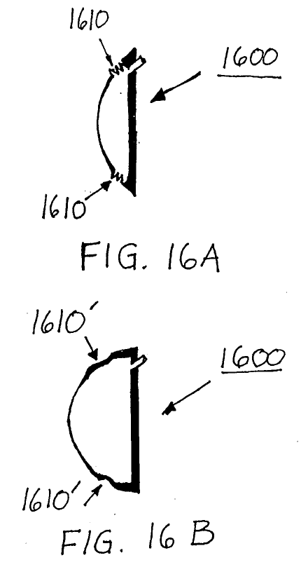

### DETAILED DESCRIPTION

Lenses and methods of manufacturing lenses and of manufacturing a flexible wall for a lens are described hereinafter. In the following description, numerous specific details, including particular fluids, rigid wall materials, flexible wall materials, focal powers and the like are set forth. However, from this disclosure, it will be apparent to those skilled in the art that modifications and/or substitutions may be made without departing from the scope and spirit of the invention. In other circumstances, specific details may be omitted so as not to obscure the invention.

Where reference is made in any one or more of the accompanying drawings to steps and/or features, which have the same or like numbered reference numerals, those steps and/or features have for the purposes of this description the same function(s) or operation(s), unless the contrary intention appears. Also, for the sake of brevity only, details of materials, shapes, configurations and the like are set forth in respect of the first embodiment. One skilled in the art will readily apprehend that, while those details may not be repeated in respect of the other embodiments, those details apply with appropriate modifications if necessary to those other embodiments, unless explicitly stated to the contrary.

In the context of this specification, the word “comprising” has an open-ended, non-exclusive meaning: “including principally, but not necessarily solely”, but neither “consisting essentially or” nor “consisting only of” Variations of the word “comprising”, such as “comprise” and “comprises”, have corresponding meanings.

The contents of the detailed description are organised into sections as follows:

### 1. A Lens Having Two Flexible Walls

### 2. Operating of the Lens

### 3. General Details of the Lens

### 4. Manufacturing Lenses and a Flexible Wall for a Lens

### 5. Another Lens Having Two Flexible Walls

6. Lenses with Welded, Bonded or Fused Flexible and Rigid Walls

### 7. Further Lenses Having Rigid and Flexible Walls

### 8. A Multiple-Element System

### 9. Lens Applications Including Cameras and Lighting Systems

The sections are described in detail hereinafter in the foregoing order.

### 1. A Lens Having Two Flexible Walls

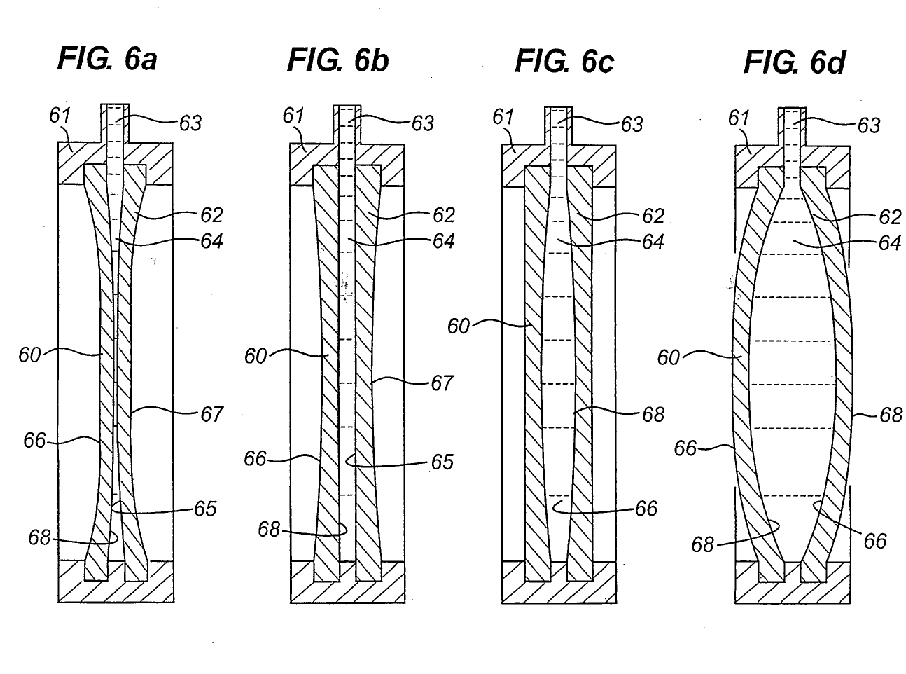

FIGS. 8a and 8b show a lens according to an embodiment of the present invention. The lens comprises a first flexible wall 80 that becomes thinner towards its central region and a second flexible wall 82, which also becomes thinner towards its central region. Each flexible wall 80, 82 is a wafer that preferably tapers to a thinner thickness at the center of the wafer than at the periphery of the wafer. The central region of the flexible wall is capable of being displaced. In this embodiment, the walls 80, 82 are configured to define a cavity for receiving fluid 84. Both walls 80, 82 are made of materials suitable for use in optical lenses.

Each flexible wall 80, 82 may be formed of a component comprising a stretchable, pliable, variform disc of synthetic homogenous material of optical clarity that is capable of variable dilatation. A flexible wall in accordance with this and other embodiments of the invention is formed from a stable, homogenous and stretchable material, which is transparent to the radiation being transmitted by the lens and which has a memory that may result in return substantially to a default original position. In this embodiment, the flexible walls 80, 82 are made of polycarbonate. While specific materials are given, it will be appreciated by one skilled in the art in the light of this disclosure that other materials may be practiced without departing from the scope and spirit of the invention. Any suitable material may be used provided the material is transparent to radiation and has the properties of being stable, stretchable or flexible, and preferably resilient. Such materials comprise, for example, silicone rubbers, plastics, acrylics, flexible polycarbonates, epoxy resins, polyesters, polymers, or thermoplastics. If welding or fusing is used to join the walls 80, 82, the walls are made of like materials. If bonding is used to join the walls 80, 82, the walls may be made of unlike materials.

The walls 80, 82 directly abut each other at the periphery and are bonded together at their respective peripheries in the depicted embodiment of FIGS. 8a and 8b. Whilst bonding the walls together is disclosed for this and other embodiments, it would be apparent to one skilled in the art that other mechanisms for holding together or housing the walls may be practised such as welding or using a barrel mounting, for example. Another method of joining the walls together that may be practiced is ultrasonic welding, which may be practiced with flexible walls 80, 82 made of thermoplastics, for example. Yet another mechanism for holding the walls together is to use annular clamping with variable loads or force. A fluid seal is formed between the peripheries of the walls 80, 82. If barrel mounting is employed, the seal between one or more of the walls 80, 82 and the barrel mounting may be effected by pressure, or in other implementations using a suitable epoxy or sealant, for example, although other sealing mechanisms may be employed without departing from the scope and spirit of the invention. In this embodiment, the two walls 80, 82 directly abut each other, provided a port is able to communicate with an internal cavity of the lens defined by the walls 80, 82.

Fluid 84 is inserted into and removed from the cavity via a port 83, which extends between the flexible walls 80, 82 into the cavity. The port 83 comprises a flexible tube bonded between the two walls 80, 82. The port 83 provides for fluid communication between the cavity and a fluid reservoir (not shown). By controlling the volume of fluid 84 in the cavity, the flexible walls 80, 82 are caused to move such that various lens shapes can be formed. The fluid 84 acts as a displacement media and is inserted into and removed from the cavity via the port 83. The displacement media is capable of displacing the flexible walls 80, 82.

The fluid 84 used to fill the lens cavity may be any homogenous, non-corrosive, or non-reactive fluid, which is transparent to the radiation being transmitted by the lens and which has suitable thermal stability so as not to be adversely affected by radiation being focused by the lens. The fluid 84 may comprise an oil, a glycerine, a silicone oil, a vegetable oil, paraffin or even a water based product. In particular, it has been found that Johnson's® Baby Oil is a suitable fluid. Preferably, the fluid 84 may be degassed, so that any heating of the fluid by radiation being transmitted by the lens does not cause bubbles to form within the lens cavity, which might adversely affect transmittal of the radiation by the lens. The fluid 84 may optionally be coloured so that the lens can additionally be used as a colour filter.

To reduce the effect of gravity on the profile of the lens, the amount of fluid 84 in the cavity is preferably minimised. This is done by reducing the distance between the first wall 80 and the second wall 82, so as to minimise the volume of the cavity. If a larger or thicker lens is required, a more thixotropic fluid could be used so as to prevent bulging towards the lowest part of the lens, and also to prevent undesired vibrations of the flexible walls 80, 82. Alternatively, a thicker flexible wall may be used. When the amount of fluid 84 in the cavity is at a minimum, the flexible walls may be almost flat against each other. In some scenarios, only a small amount of fluid separates the two walls 80, 82.

The flexible walls 80, 82 may be flexed by forcing the fluid 84 into the cavity or removing fluid 84 from the cavity, so as to produce positive or negative lens profiles. A flexible wall in accordance with this and other embodiments of the invention may have a shallow profile and be thin and contractible and/or expandable radially. At its thinnest point, the flexible wall 80, 82 may have a thickness of a few millimetres or less. The thinnest point of the flexible wall 80, 82 generally corresponds to the physical and/or optical centre of the lens. Peripheral to its thinnest point, the flexible wall 80, 82 may be of considerable thickness depending upon the diameter of lens required and the size of clear aperture required. The flexible wall 80, 82 may also be resilient.

The thickness of each flexible wall 80, 82 may be increased for larger diameter optical systems so that the flexible wall 80, 82 has a reduced flexibility and the effect of gravity on the fluid in the cavity is reduced. Such reduced flexibility prevents bulging of the flexible wall 80, 82 towards the bottom of the flexible wall 80, 82 and ensures a consistent profile around the circumference of the flexible wall 80, 82. The thickness of the flexible wall 80, 82 may also be altered for systems requiring more or less profile flexure and variation.

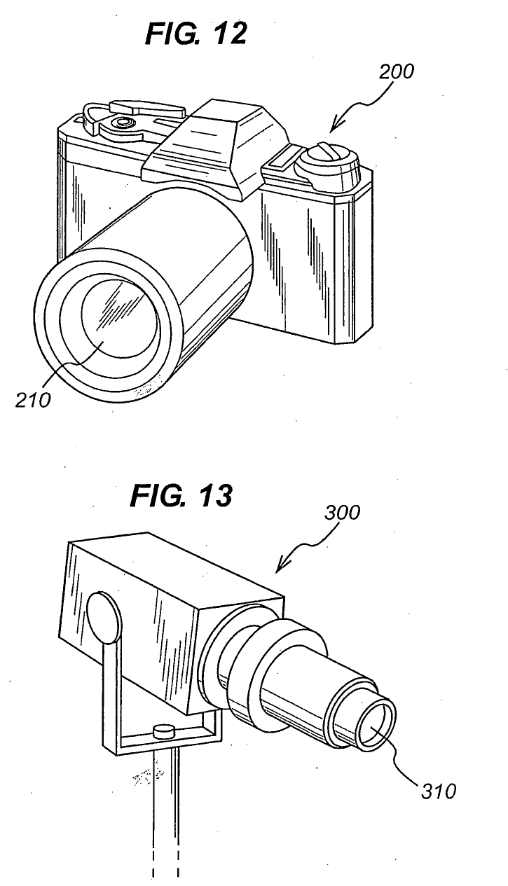

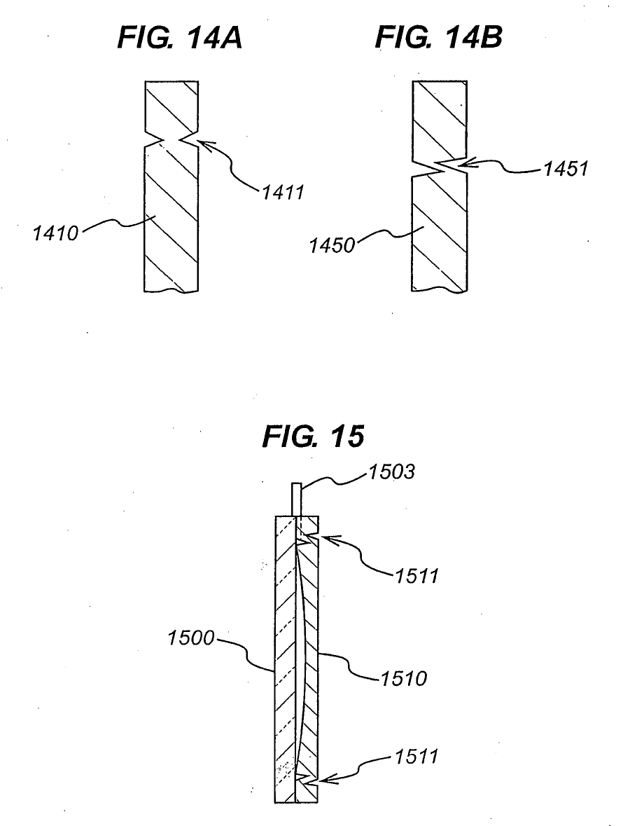

In this embodiment, the flexible walls 80, 82 are provided with two annular grooves 81, one in each surface of the walls 80, 82 in a configuration where the grooves 81 are on opposite sides of one another. While two opposite facing grooves are implemented in the embodiment shown in FIGS. 8a and 8b, a single annular groove could be practiced in another implementation on either surface of each wall, but preferably in a surface of each wall 80, 82 that forms an interior surface of the cavity between the walls 80, 82. Two annular grooves 81 in opposite surfaces of the wall 80, 82 are preferred, since this configuration works well as a hinge. However, a single groove in one surface of the wall 80, 82 may be practiced. This may involve making a deeper groove in the wall 80, 82 to provide an acceptable hinge function. In yet other embodiments of the invention, two annular grooves may be practiced, but rather than: being positioned opposite each other, the two grooves may be displaced relative to each other as depicted in FIGS. 14B and 15, which are described hereinafter. In such an embodiment, deeper grooves may be practiced.

In FIG. 14A, two oppositely positioned annular grooves 1411 are formed in the flexible wall 1410. However, as shown in FIG. 14B, deeper grooves 1451 may be formed in the opposite walls of the flexible wall 1450 and be offset or displaced relative to each other. Further, the grooves 1451 may be deeper than in the case of FIG. 14A. The grooves 1451 of FIG. 14B may function well as a hinge. The design of FIG. 14B may relieve most if not all compression and tensile forces involved as well as enabling the use of a slightly less flexible material for the wall 1450. This in turn would counteract effects of gravity and the possible pear shaped problem.

Referring again to the embodiment of FIG. 8, the annular grooves 81 have a v-shaped cross-section, one on each surface of the wall, and are positioned adjacent to the periphery of the walls 80, 82, where the two walls are joined (e.g., by bonding, welding or fusing). The exact position of each groove 81 can be varied relative to the peripheral edge of the wall 80, 82. The annular grooves shown in FIGS. 8a and 8b have “rounded” or “blunt” v-shape cross-sections preferably. Alternatively, the groove 81 may have a “sharp” v-shaped cross section. The grooves act as hinges to improve the consistency of the curvature of the flexible walls 80, 82 across their surfaces. The grooves 81 have a v-shaped cross section in this embodiment, but other shaped grooves may be practiced, for example, c-shaped grooves. Generally, v-shaped grooves are preferred over c-shaped grooves, since v-shaped grooves are more accurate.

The depth of the groove bases is such that the distance between the two bases is the same or substantially the same as the thickness of the flexible wall 80, 82 at its centre. While the distances are the same or substantially the same as the thickness of the flexible wall 80, 82 at its center in this embodiment, other distances between the groove bases may be practised without departing from the scope and spirit of the invention provided the resulting grooves function sufficiently as a hinge.

The grooves 81 in the inner surfaces of the flexible walls 80, 82 may facilitate the dispersion of the fluid 84 from each port 83 between the two walls 80, 82, especially in configurations where the two walls 80, 82 are closely spaced together or directly abut each other, leaving little or no cavity between the two walls 80, 82 without displacement media held between the walls 80, 82. In embodiments, such as the one shown in FIGS. 8a and 8b, the internal grooves 81 are advantageous where the two walls are chemically bonded together, as the grooves 81 tend to collect any chemical solvent that might drip or enter between the walls 80,82 in the grooves 81 before the solvent can go farther into the cavity.

The outer surface 86 of the flexible wall 80 and the outer surface 85 of the flexible wall 82 are the operative surfaces of the lens.

### 2. Operation of the Lens

In FIG. 8a, the amount of fluid 84 is controlled so that the first flexible wall 80 is positioned such that a first surface 86 of that wall 80 farthest from the second flexible wall 82 is substantially planar and a second surface 88 of the first flexible wall 80 closest to the second flexible wall 82 is concave. In addition, the amount of fluid determines that the second flexible wall 82 is positioned such that a first surface 85 of that wall 82 closest to the first flexible wall 80 is concave and a second surface 87 farthest from the first flexible wall 80 is substantially planar.

In FIG. 8b, the amount of fluid 84 is controlled so that the first flexible wall 80 is positioned such that its first surface 86 farthest from the second flexible wall 82 is convex and its second surface 88 closest to the second flexible wall 82 is concave. Similarly, the amount of fluid determines that the second flexible wall 82 is positioned such that its first surface 85 closest to the first flexible wall 80 is concave and its second surface 87 farthest from the first flexible wall 80 is convex. By changing the amount of fluid 84 in the cavity from the amount shown in FIG. 8a to the amount shown in FIG. 8b, the focusing power of the lens is changed to a more positive power. For example, the lens in various embodiments described herein may have a power range of from about −9 to about +9 Dioptres, or at least cover a portion of that range. Other powers may be practiced without departing from the scope and spirit of the invention.

### 3. General Details of the Lens

Thus, the foregoing embodiment of the invention provides a lens comprising first and second walls 80, 82 defining a cavity for receiving fluid 84. In this embodiment, both walls 80, 82 are flexible and become progressively thinner towards the central region of each wall 80, 82, such that various lens shapes can be formed by controlling the volume of fluid 84 within the cavity. Each such flexible wall 80, 82 provides greater strength, better memory and a superior quality of flexure than planar-wall based systems. Such flexible walls also influence (i.e. preferentially inflates or deflates) the central region and allow the exact change of profile through the range to be accurately defined. In other embodiments of the invention described hereinafter, rather than two flexible walls, a single flexible wall may be used in combination with a rigid wall instead of a second flexible wall.

The at least one groove 81 towards its perimeter defines a hinge such that various lens shapes can be formed by controlling the volume of the fluid 84 within the cavity. In the foregoing embodiment of the invention and other embodiments of the invention described hereinafter, the lens is variable. The lens may rely on a closed-circuit fluid actuation to variably and smoothly alter, within limits, the profile, and hence the focal length of the lens.

A lens according to this embodiment of the invention and those described hereinafter can be used to replace any lens currently produced from glass, acrylic, composite or any other material which refracts the radiation that the lens is being used to transmit. Such a lens can be used within any focusing system, whether the system is of simple single element or multi-element design. The use of such a lens leads to a continuously variable hydraulic lens system. Specific applications in which a lens according to the embodiments of the invention may be used comprise consumer optics (mobile phone cameras, professional and non-professional cameras, still and video cameras), lighting, optometry and ophthalmology, toy optics, watch faces, automotive optics and certain types of industrial, chemical and military optics. Lenses according to one or more embodiments of the invention are particularly suitable for use in simple, single element focus and zoom units.

While the second wall 82 in this embodiment is flexible, in other embodiments as described hereinafter, the second wall may be rigid. When both the first and second walls are flexible, the two walls may be worked against each other.

Lenses according to this and other embodiments of the invention may be circular. The lenses may have very small or very large diameters. The size and configurations of the walls 80, 82 may vary dependent upon the application and configuration of the lens. Generally speaking the at least one annular groove is formed in a surface of the wall near the periphery of the wall.

In other embodiments, the second wall may be formed from a rigid material and may be defined by a first surface and a second surface substantially parallel to the first surface. Consequently, the flexible wall 80 may be worked against the rigid planar surface. Again, the rigid material may be a polycarbonate, an acrylic or a glass, for example. In other embodiments of the invention, as described hereinafter, the second wall may be formed from a rigid material and may be defined by a first surface and a second surface, wherein at least one of the first and second surfaces is a concave surface. Alternatively, the second wall may be formed from a rigid material and may be defined by a first surface and a second surface, wherein at least one of the first and second surfaces is a convex surface. Consequently the rigid second wall may take any profile, and the flexible first wall may be worked against any profile second wall. The rigid material of the second wall may comprise a glass or acrylic which is transparent to the radiation being transmitted by the lens.

In other embodiments described hereinafter, the first and second walls of the lens are supported within a mounting, preferably a barrel mounting. If the first and second walls are bonded together directly, close to their respective peripheries, there is no need for a complex mechanical seal to be formed between the mounting and the walls. Instead, the fluid is contained within the cavity formed by the two walls and the arrangement is simpler and cheaper to manufacture and may be less likely to fail in use. The first and second walls may be bonded together using a flowable fluid silicone rubber compound (for example that available from RS components with Stock No. 692-542). The compound may comprise triacetoxy(ethyl)silane or methyl triacetoxy(ethyl)silane. Alternatively, the first and second walls may be welded, chemically bonded, or fused together. Such fusion may involve heating at least a portion of the walls. These methods of joining the two walls together offer the same advantages over the barrel mounting as does bonding the walls together.

The lens in accordance with this and other embodiments of the invention further comprises at least one port into the cavity through which fluid can flow. More preferably, while only a single port 83 is shown in FIGS. 8a and 8b, the lens comprises a plurality of ports 83 into the cavity through which fluid can flow. The plurality of ports 83 are spaced around a circumference of the lens. The plurality of ports 83 may be equally spaced around the circumference of the lens. For example, the lens may comprise three ports 83 spaced from each other by an angle of approximately 120°. By equally spacing the ports around the circumference of the lens, the lens is more likely to have a rotationally symmetric profile, because the fluid 84 is more likely to be equally distributed within the cavity. Fluid 84 may be allowed to flow both into and out of the cavity through the at least one port 83.

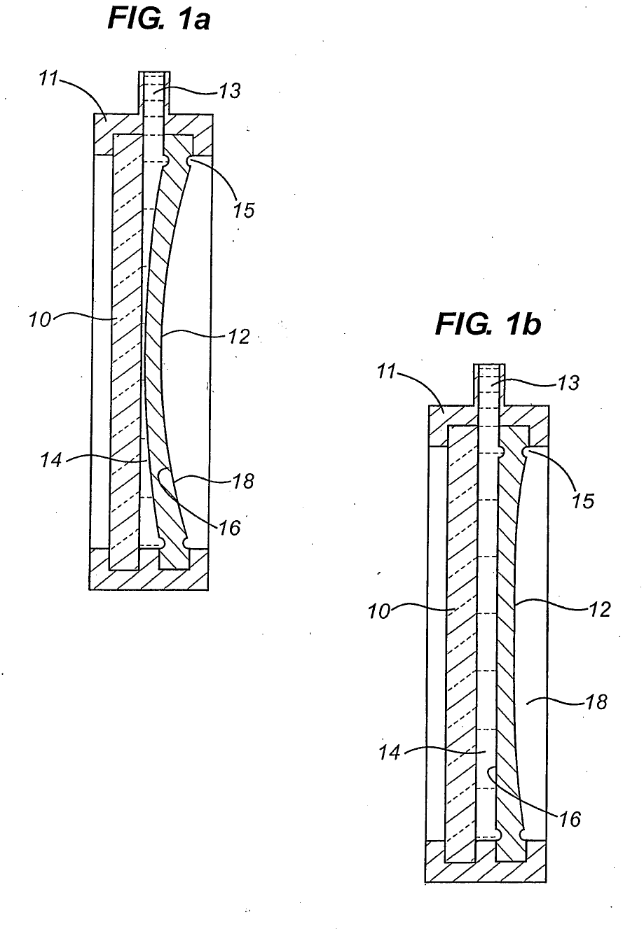

When the walls of the lens are supported with a barrel mounting, each port may extend through the barrel mounting, as described hereinafter with reference to the embodiment shown in FIGS. 1a to 1d. Alternatively, each port may extend through the flexible wall of the lens, or through the rigid wall of the lens. Alternatively, the port may be bonded between the first and second walls. The port may comprise a tube bonded or fused to a hole drilled or moulded through one of the walls. For example, the tube could be a polythene or silicone tube bonded with a suitable solvent to a hole drilled through or moulded into a polycarbonate lens. The tube could also be formed of acrylic or polycarbonate and could be welded or bonded to one of the walls. The tube may be of suitable diameter for the lens size. If the port extends between the first and seconds walls or through the flexible wall of the lens, the entrance of the port into the cavity may correspond with a groove formed in the inside surface of the flexible wall.

A fluid reservoir may be connected to the lens via the at least one port so as to communicate fluid to and from the cavity formed by the walls. The fluid reservoir may be incorporated into the final lens assembly, so that the system forms a closed circuit, discreet, sealed package with a reservoir and a lens cavity permanently connected via at least one port. For example, the fluid reservoir may be contained within the barrel mounting in which the walls are housed.

The fluid 84 may be moved from the reservoir to the cavity and vice versa using a pump, a piston, a plunger, a conventional focus barrel, or any force-provider applied to the outside of the reservoir, which can be used to expel fluid from the reservoir or withdraw fluid from the lens cavity. Preferably, therefore, the reservoir may have sufficient resilience and strength of memory to work efficiently in tandem with each flexible wall to produce a positive driving force to move the fluid in the desired direction between the reservoir and lens cavity. The force-provider may be used to pump fluid into and out of the cavity to thus expand and deflate the lens. The force-provider may also be used to cause a vacuum to pull the flexible wall in towards the cavity.

When each flexible wall 80, 82 comprises at least one groove 81 in the surface adjacent the cavity in accordance with this and other embodiments of the invention, the at least one groove may be integral with the at least one port. Alternatively, the lens may comprise a continuous channel for supplying fluid via the groove to the lens cavity. The groove in the surface of the wall adjacent the cavity may facilitate dispersion of the fluid around the cavity when the fluid initially enters the cavity. This is especially so for lens configurations where the two walls are closely spaced together or initially abutting one another, leaving little or no cavity between the two walls. For example, the fluid may flow around the groove until the walls separate from one another, thus helping to disperse the fluid within the cavity.

When the flexible wall comprises a groove, the groove may be positioned close to the periphery of the lens at the point of maximum flexure. Such a groove acts as a hinge. The groove may be annular and may be formed on either surface of the first wall, that is, either the surface closest to the second wall or the surface farthest from the second wall. The groove may be positioned at an appropriate distance from the periphery of the first wall to allow for welding or bonding of the first wall to the second wall. When the lens comprises a groove and the first wall is defined by a first surface and a second surface, the groove may be formed in the first surface of the first wall. The first surface of the first wall may be a concave surface and the second surface of the first wall may be a planar surface. Alternatively, both the first surface and the second surface of the first wall may be concave surfaces. Alternatively, both the first surface and the second surface of the first wall may be planar surfaces.

When fluid is supplied to the cavity or removed from the cavity, one surface of the flexible wall takes a convex shape and one surface of the flexible wall takes a concave shape. Any groove on the convex surface acts to relieve tension forces in that surface, whilst any groove in the concave surface acts to relieve compression forces in that surface. As a result, an improved, smoother, curvature of lens is produced.

When the first wall is defined by a first surface with a groove and a second surface, the first wall may also have a second groove towards the perimeter of the first wall, wherein the second groove, is formed in the second surface of the first wall. When the flexible wall comprises a groove on each surface, the two grooves are preferably aligned.

If a wall of the lens has at least one groove, the groove may have a v-shaped cross-section. The groove is preferably blunt-ended or has a rounded base to relieve stresses in the flexible wall close to the groove. For example, the groove may have a c-shaped cross-section. A groove which is blunt-ended or has a rounded base is preferable because the flexible wall is less likely to fatigue or fracture in use when such a groove is used.

When a groove is formed in the first surface of the first wall, the first wall may become progressively thinner towards its central region and the depth of the groove may be such that the least distance between an apex or base of the groove and the second surface is substantially the same as the thickness of the first wall at its central region.

When flexible wall has a groove in each surface of the flexible wall, the flexible wall may become progressively thinner towards its central region and grooves may be arranged so that the distance between the apexes or bases of the grooves is substantially the same as the thickness of the flexible wall at its central region.

### 4. Manufacturing Lenses and a Flexible Wall for a Lens

Moulding of flexible walls may be accurately executed against “female” profile glass, acrylic or silica optics, high quality plastic moulds, or by spinning, centrifuging, introduction of gas, bubble or flow, pour, draw vacuum technology for example. Self-levelling characteristics of pre-cured materials are especially valuable. Alternatively, moulding of flexible walls may be executed by injection moulding. For example, thermoplastics can be injection moulded to form the flexible walls. All moulding surface materials must be stable, non-adhesive to the flexible walls being produced, and have sufficiently high grade surface characteristics so as to impart substantially perfect surface qualities to the flexible walls being cast. Alternatively, the flexible walls may be stamped from a sheet of suitable material.

### 5. Another Lens Having Two Flexible Walls

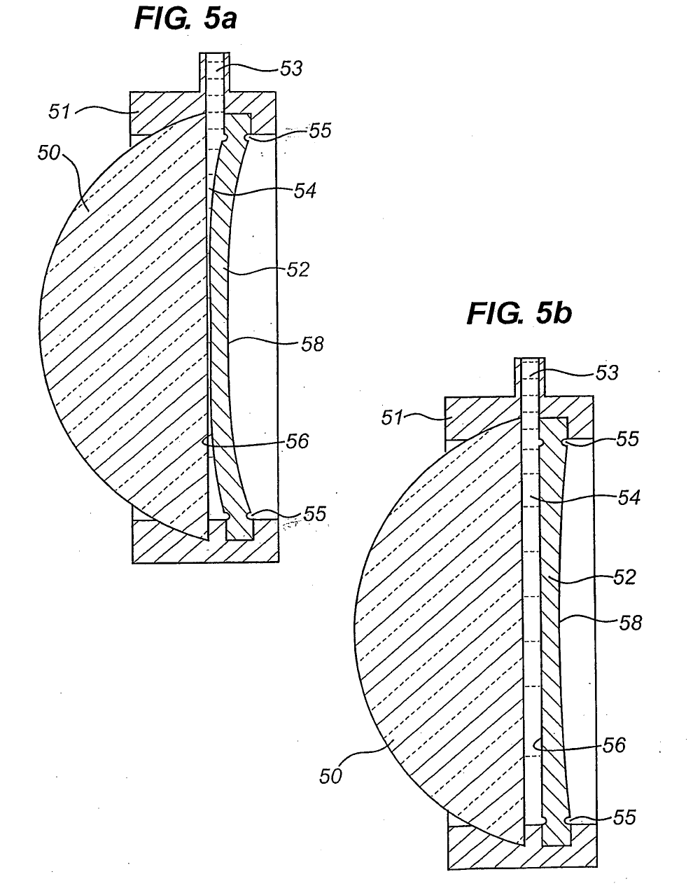

FIGS. 6a to 6d show a lens having two flexible walls 60, 62 according to another embodiment of the present invention. The lens comprises a first flexible wall 60 that becomes thinner towards its central region and a second flexible wall 62 that also becomes thinner towards its central region. The first and second walls 60, 62 define a cavity for receiving fluid 64. The walls 60, 62 may be made of similar materials and joined together in accordance with the foregoing embodiment described hereinbefore with reference to FIGS. 8a and 8b. The embodiment shown in FIGS. 6a to 6d does not have annular grooves formed in the walls 60, 62 to function as hinges. Further, the walls 60, 62 are not welded, bonded or fused together. Instead, the flexible walls 60, 62 are housed in parallel in a barrel mounting 61.

The walls 60, 62 again are spaced apart relative to each other and are fitted in annular grooves in the interior surface of a barrel mounting 61. The spacing or separation between the walls 60, 62 is exaggerated (i.e., more spaced apart) in FIG. 6 for purposes of illustration only. The walls 60, 62 are preferably spaced much closer together to minimise the amount of fluid 64 between the walls 60, 62, and in fact the walls 60, 62 may directly abut one another. Each of the walls 60, 62 has a flat peripheral edge for engagement with a square notch-type groove in the mounting 61. The walls 60, 62 are housed in the barrel mounting 61. Whilst a barrel mounting is disclosed for this and other embodiments, it would be apparent to one skilled in the art that other mechanisms for holding together the walls may be practised such as bonding or welding, for example. The fluid 64 is inserted into and removed from the cavity via a port 63, which extends through the barrel mounting 61 into the cavity. The port 63 provides for fluid communication between the cavity and a fluid reservoir (not shown). By controlling the volume of fluid 64 in the cavity, the flexible walls 60, 62 are caused to move such that various lens shapes can be formed.

While the flexible walls 60, 62 depicted in FIGS. 6a to 6d do not have annular grooves formed in the surfaces of the walls 60, 62, one or more annular grooves may be formed in such walls 60, 62 held in place by the barrel mounting 61. Also, while barrel mounting is depicted in FIGS. 6a to 6d, other mechanisms of joining together the walls 60, 62 may be practiced, including bonding, welding, fusing, and ultrasonic welding, amongst other techniques known to those skilled in the art.

In FIG. 6a, the amount of fluid 64 is controlled so that the first flexible wall 60 is positioned such that a first surface 66 of that wall 60 farthest from the second flexible wall 62 is concave and a second surface 68 closest to the second flexible wall 62 is convex. In addition, the amount of fluid 64 determines that the second flexible wall 62 is positioned such that a first surface 65 of that wall 62 closest to the first flexible wall 60 is convex and a second surface 67 farthest from the first flexible wall 60 is concave.

In FIG. 6b, the amount of fluid 64 is controlled so that the first flexible wall 60 is positioned such that its first surface 6 farthest from the second flexible wall 62 is concave and its second surface 68 closest to the second flexible wall 62 is substantially planar. Similarly, the amount of fluid 64 determines that the second flexible wall 62 is positioned such that its first surface 65 closest to the first flexible wall 60 is substantially planar and its second surface 67 farthest from the first flexible wall 62 is concave.

In FIG. 6c, the amount of fluid 64 is controlled so that the first flexible wall 60 is positioned such that its first surface 66 farthest from the second flexible wall 62 is substantially planar and its second surface 68 closest to the second flexible wall 62 is concave. In addition, the amount of fluid determines that the second flexible wall 62 is positioned such that its first surface 65 closest to the first flexible wall 60 is concave and its second surface 67 farthest from the first flexible wall 62 is substantially planar.

In FIG. 6d, the amount of fluid 64 is controlled so that the first flexible wall 60 is positioned such that its first surface 66 farthest from the second wall 62 is convex and its second surface 68 closest to the second wall 62 is concave. In addition, the amount of fluid determines that the second flexible wall 62 is positioned such that its first surface 65 closest to the first flexible wall 60 is concave and its second surface 67 farthest from the first flexible wall 62 is convex.

By changing the amount of fluid 64 in the cavity from the amount shown in FIG. 6a to the amount shown in FIG. 6d, the focusing power of the lens is changed from negative to positive.

6. Lenses with Welded, Bonded or Fused Flexible and Rigid Walls

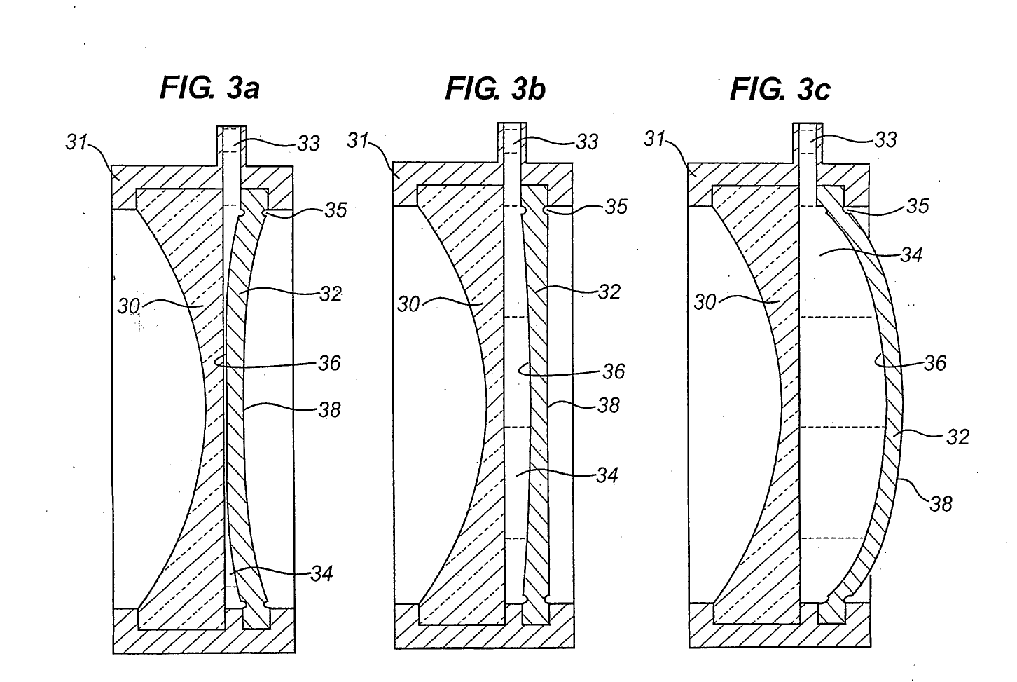

FIGS. 4a and 4b show a lens according to still another embodiment of the present invention. The lens comprises a flexible wall 40 that becomes thinner towards its central region and a rigid meniscus concave wall 42. The curved surface of the rigid wall 42 faces the flexible wall 40, while the planar surface of the rigid wall 42 faces away from the flexible wall 40. The walls 40, 42 define a cavity for receiving fluid 44. The flexible wall 40 is provided with two annular grooves 41, one in each surface of the wall. The v-shaped grooves act as a hinge for the flexible wall 40. Other shaped grooves may be practiced. In this embodiment, the walls 40 and 42 directly abut one another. A barrel mounting is not used to house the walls 40, 42 in the embodiment shown in FIGS. 4a and 4b. Instead, the walls 40, 42 are bonded together at their respective peripheries. Whilst bonding is disclosed for this and other embodiments, it would be apparent to one skilled in the art that other mechanisms for holding together the walls may be practised such as welding or the use of a barrel mounting, for example. The walls are bonded together at a point adjacent to the outermost edge of the groove 41 in the flexible wall 40 facing the rigid wall 42. The port extends from the peripheral edge of the rigid wall 42 though to an internal curved surface of that rigid wall 42 in this embodiment. The fluid 44 is inserted into and removed from the cavity via a port 43, which extends through the rigid wall 42 into the cavity and comprises a flexible tube bonded to or bonded into a hole drilled through the rigid wall 42. The port 43 provides for fluid communication between the cavity and a fluid reservoir (not shown). By controlling the volume of fluid 44 in the cavity, the flexible wall 40 is caused to move such that various lens shapes can be formed.

Thus, in this embodiment, the lens comprises the first flexible wall 40 and the second wall 42 defining a cavity for receiving the fluid 44. Various lens shapes can be formed by controlling the volume of fluid within the cavity, and the first wall 40 and second wall 42 are bonded, welded or fused together.

For example, in FIG. 4a, the amount of fluid 44 is controlled so that the flexible wall is positioned such that a first surface 46 closest to the rigid wall 42 is convex and a second surface 48 farthest from the rigid wall 42 is concave.

In FIG. 4b, the amount of fluid 44 is controlled so that the flexible wall 40 is positioned such that the first surface 46 closest to the rigid wall 42 is concave and the second surface 48 farthest from the second rigid wall 42 is convex.

By changing the amount of fluid 44 in the cavity from the amount shown in FIG. 4a to the amount shown in FIG. 4b, the focusing power of the lens is changed from negative to positive.

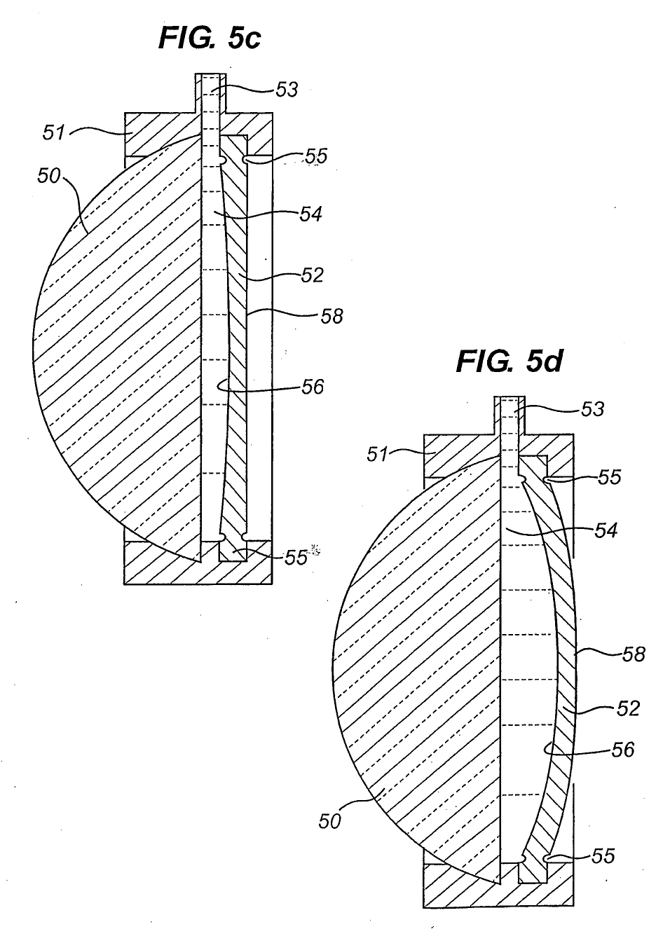

FIGS. 7a and 7b show a lens according to a further embodiment of the present invention. The lens comprises a flexible wall 70 that becomes thinner towards its central region and a piano convex rigid wall 72. The walls 70, 72 define a cavity for receiving fluid 74. The planar surface of the rigid lens 72 faces the flexible wall 70, while the curved surface of the rigid wall 72 faces away from the flexible wall 70. The flexible wall 70 is provided with an annular groove 71, in the outer surface of the flexible wall 70. The groove acts as a hinge to improve the consistency of the curvature of the flexible wall 40 across its surfaces. While a single annular groove 71 is depicted in FIGS. 7a and 7b, the wall 70 may have two annular grooves, e.g. like the configuration shown in FIGS. 4a and 4b, for example. Alternatively, the wall 70 may be implemented without grooves. The walls 70, 72 directly abut each other and are welded together at their respective peripheries. Whilst welding the walls together is disclosed for this and other embodiments, it would be apparent to one skilled in the art that other mechanisms for holding together the walls may be practised such as bonding or using a barrel mounting, for example. The fluid 74 is inserted into and removed from the cavity via a port 73 which extends through the rigid wall 72 into the cavity and comprises a flexible tube bonded to or into a hole drilled through the rigid wall 72. The port 73 provides for fluid communication between the cavity and a fluid reservoir (not shown). By controlling the volume of fluid 74 in the cavity, the flexible wall 70 is caused to move such that various lens shapes can be formed. For example, in FIG. 7a, the amount of fluid 74 is controlled so that the flexible wall is positioned such that a first surface 76 closest to the rigid wall 72 is concave and a second surface 78 farthest from the rigid wall 72 is substantially planar.

In FIG. 7b, the amount of fluid 74 is controlled so that the flexible wall 70 is positioned such that the first surface 76 closest to the rigid wall 72 is concave and the second surface 78 farthest from the second rigid wall 72 is convex.

By changing the amount of fluid 74 in the cavity from the amount shown in FIG. 7a to the amount shown in FIG. 7b, the focusing power of the lens is changed to be more positive.

### 7. Further Lenses Having Rigid and Flexible Walls

FIGS. 1a to 1d show a lens according to a further embodiment of the present invention. The lens comprises a planar rigid acrylic wall 10 and a flexible polycarbonate wall 12, which becomes thinner towards its central region. Both walls are made of materials suitable for use in optical lenses. While specific materials are given, it will be appreciated by one skilled in the art in the light of this disclosure that other materials may be practiced without departing from the scope and spirit of the invention.

For example, the rigid wall 10 may alternatively be made of glass, a polycarbonate, or a composite.

The flexible wall 12 is a wafer that preferably tapers to a thinner thickness at the center of the wafer than at the periphery of the wafer. The flexible wall 12 may be formed of a component comprising a stretchable, pliable, variform disc of synthetic homogenous material of optical clarity that is capable of variable dilatation. A flexible wall in accordance with this and other embodiments of the invention is formed from a stable, homogenous and stretchable material, which is transparent to the radiation being transmitted by the lens and which has a memory that may result in return substantially to a default original position. Such materials comprise, for example, silicone rubbers, plastics, acrylics, flexible polycarbonates, epoxy resins, polyesters or thermoplastics. Any suitable material may be used provided the material is transparent to radiation and has the properties of being stable, stretchable or flexible, and preferably resilient. The central region of the flexible wall is capable of being displaced relative to the rigid wall. In this embodiment, the walls 10, 12 are configured to define a cavity for receiving fluid 14 by spacing apart the walls 10, 12.

The walls 10, 12 are circular in form and are housed in a barrel mounting 11, which is tubular or cylindrical in form. In this embodiment, the internal surfaces of the barrel mounting 11 define the cavity as well. The walls 10, 12 are spaced apart relative to each other and are fitted in annular grooves in the interior surface of the barrel mounting 11. Each of the walls 10, 12 has a flat peripheral edge for engagement with a square notch-type groove in the mounting 11. A fluid seal is formed between the periphery of each of the walls 10, 12 and the barrel mounting 11. The seal between one or more of the walls 10, 12 and the barrel mounting 11 may be effected by pressure, or in other implementations using a suitable epoxy or sealant, for example, although other sealing mechanisms may be employed without departing from the scope and spirit of the invention. While the walls 10, 12 are spaced apart in this embodiment, using separate grooves in the barrel mounting, this need not be the case. For example, the two walls 10, 12 may directly abut each other in a single groove formed in the barrel mounting, provided a port is able to communicate with an internal cavity of the lens defined by the walls 10, 12. Whilst a barrel mounting is disclosed for this and other embodiments, it would be apparent to one skilled in the art that other mechanisms for holding together the walls may be practised such as bonding or welding, for example, provided that fluid seal is formed between the walls. The fluid 14 acts as a displacement media and is inserted into and removed from the cavity via a port 13, which extends through the barrel mounting 11 and communicates with the cavity. The displacement media is capable of displacing the flexible wall 12 relative to the rigid wall 10. The port 13 provides for fluid communication between the cavity and a fluid reservoir (not shown). By controlling or varying the volume of fluid 14 in the cavity, the flexible wall 12 moves such that various lens shapes can be formed.

The fluid 14 used to fill the lens cavity may be any homogenous, non-corrosive, or non-reactive fluid, which is transparent to the radiation being transmitted by the lens and which has suitable thermal stability so as not to be adversely affected by radiation being focused by the lens. The fluid 14 may comprise an oil, a glycerine, a silicone oil, a vegetable oil, paraffin or even a water based product. In particular, it has been found that Johnson's® Baby Oil is a suitable fluid. Preferably, the fluid 14 may be degassed, so that any heating of the fluid by radiation being transmitted by the lens does not cause bubbles to form within the lens cavity, which might adversely affect transmittal of the radiation by the lens. The fluid 14 may optionally be coloured so that the lens can additionally be used as a colour filter.

To reduce the effect of gravity on the profile of the lens, the amount of fluid 14 in the cavity is preferably minimised. This is done by reducing the distance between the first wall 12 and the second wall 10, so as to minimise the volume of the cavity. If a larger or thicker lens is required, a more thixotropic fluid could be used so as to prevent bulging towards the lowest part of the lens, and also to prevent undesired vibrations of the flexible wall 12. Alternatively, a thicker flexible wall may be used. When the amount of fluid 14 in the cavity is at a minimum, the flexible wall may be almost flat against the rigid wall, with a small amount of fluid separating the two walls.

The flexible wall 12 may be flexed by forcing the fluid 14 into the cavity or removing fluid 14 from the cavity, so as to produce positive or negative lens profiles. A flexible wall in accordance with this and other embodiments of the invention may have a shallow profile and be thin and contractible and/or expandable radially. At its thinnest point, the flexible wall 12 may have a thickness of a few millimetres or less. The thinnest point of the flexible wall 12 generally corresponds to the physical and/or optical centre of the lens. Peripheral to its thinnest point, the flexible wall 12 may be of considerable thickness depending upon the diameter of lens required and the size of clear aperture required. The flexible wall 12 may also be resilient.

The thickness of the flexible wall 12 may be increased for larger diameter optical systems so that the flexible wall 12 has a reduced flexibility and the effect of gravity on the fluid in the cavity is reduced. Such reduced flexibility prevents bulging of the flexible wall 12 towards the bottom of the flexible wall 12 and ensures a consistent profile around the circumference of the flexible wall 12. The thickness of the flexible wall 12 may also be altered for systems requiring more or less profile flexure and variation.

In this embodiment, the flexible wall 12 is provided with two annular grooves 15, one in each surface of the wall 12 in a configuration where the grooves 15 are on opposite sides of one another. In this embodiment, the outermost edge of the grooves 15 is positioned at or adjacent to the internal surface of the barrel mounting 11. The grooves 15 have a c-shaped cross section in this embodiment, but other shaped grooves may be practiced, for example, v-shaped grooves. The depth of the groove bases is such that the distance between the two bases is the same or substantially the same as the thickness of the flexible wall 12 at its centre. While the distances are the same or substantially the same as the thickness of the flexible wall 12 at its center in this embodiment, other distances between the groove bases may be practised without departing from the scope and spirit of the invention provided the resulting grooves function sufficiently as a hinge. The grooves 15 act as hinges to improve the consistency of the curvature of the flexible wall 12 across its surfaces. The groove 15 in the inner surface of the flexible wall 12 may facilitate the dispersion of the fluid 14 from the port 13 between the two walls 10, 12, especially in configurations where the two walls 10, 12 are more closely spaced together or directly abut each other, leaving little or no cavity between the two walls 10, 12 without displacement media held between the walls 10, 12.

In FIG. 1a, the amount of fluid is controlled or varied, so that the flexible wall 12 is positioned such that a first surface 16 closest to the rigid wall 10 is convex and a second surface 18 farthest from the rigid wall 10 is concave. This flexing of the flexible wall 12 or displacement of its central region may be effected by suction of the fluid 14 out of the cavity into the fluid reservoir (not shown).

In FIG. 1b, the amount of fluid is controlled or varied, so that the flexible wall 12 is positioned such that the first surface 16 closest to the rigid wall 10 is substantially planar and the second surface 18 farthest from the rigid wall 10 is concave.

In FIG. 1c, the amount of fluid is controlled so that the flexible wall is positioned such that the first surface 16 closest to the rigid wall 10 is concave and the second surface 18 farthest from the rigid wall 10 is substantially planar.

In FIG. 1d, the amount of fluid is controlled so that the flexible wall is positioned such that the first surface 16 closest to the rigid wall 10 is concave and the second surface 18 farthest from the rigid wall 10 is convex.

By changing the amount of fluid 14 in the cavity from the amount shown in FIG. 1a to the amount shown in FIG. 1d, the focusing power of the lens is changed from a negative power to a positive power. For example, the lens may have a power range of from about −9 to about +9 Dioptres. Other powers may be practiced without departing from the scope and spirit of the invention.

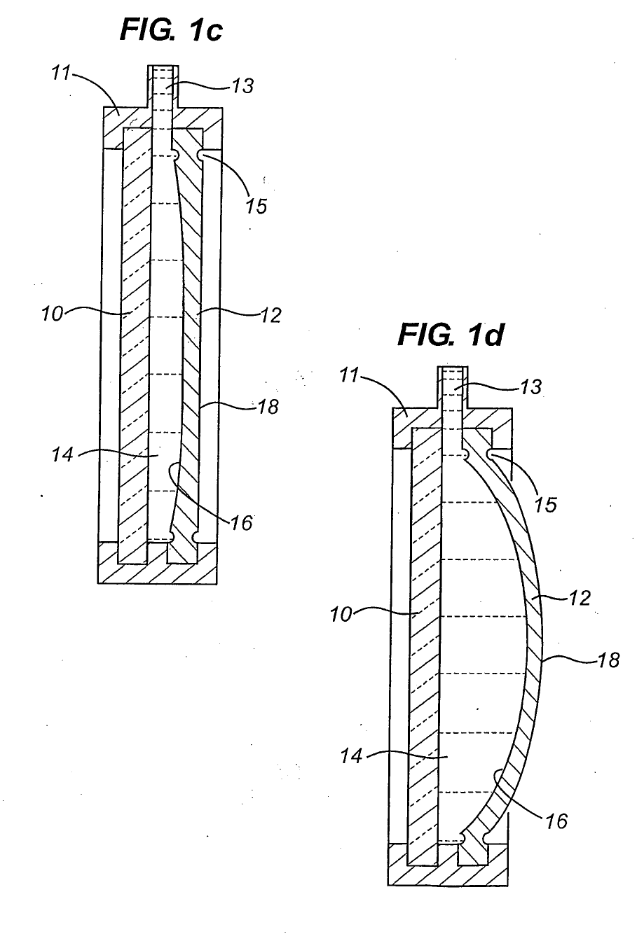

FIGS. 2a and 2b show a lens according to another embodiment of the present invention. The lens comprises a flexible wall 20, which becomes thinner towards its central region and a rigid meniscus convex wall 22. The latter wall 22 is thicker at its center than at its periphery. Again, the two walls 20, 22 may be made of materials described respectively in respect of the walls 10, 12 of the first embodiment. The walls 20, 22 define a cavity for receiving fluid 24. The flexible wall 20 is provided with an annular groove 25 on a first surface 26 thereof. The groove 25 has a c-shaped cross section, but other shaped grooves may be practiced, and the distance between the base of the groove 25 and the other surface 28 of the flexible wall 20 is the same or substantially the same as the thickness of the flexible wall 20 at its centre. Again, while the distance is the same or substantially the same in this embodiment, other distances between the groove base and the other surface 28 may be practised provided the resulting groove functions sufficiently as a hinge. The groove 25 acts as a hinge to improve the consistency of the curvature of the flexible wall across its surfaces.

The walls 20, 22 are housed in a barrel mounting 21. Whilst a barrel mounting is disclosed for this and other embodiments, it would be apparent to one skilled in the art that other mechanisms for holding together the walls may be practised such as bonding or welding, for example. The configuration of the barrel mounting 21 and the configuration of the walls and the mounting are the same as that described in FIGS. 1a to 1d. The fluid 24 is inserted into and removed from the cavity via port 23 which extends through the barrel mounting 21 into the cavity. The port 23 provides for fluid communication between the cavity and a fluid reservoir (not shown). By controlling the volume of fluid 24 in the cavity, the flexible wall 20 is caused to move such that various lens shapes can be formed. In FIG. 2a, the amount of fluid is controlled so that the flexible wall 20 is positioned such that a first surface 26 closest to the rigid wall 22 is convex and a second surface 28 farthest from the rigid wall 22 is concave.

In FIG. 2b, the amount of fluid is controlled so that the flexible wall 20 is positioned such that the first surface 26 closest to the rigid wall 22 is convex and the second surface 28 farthest from the rigid wall 10 is concave.

By changing the amount of fluid 24 in the cavity from the amount shown in FIG. 2a to the amount shown in FIG. 2b, the focusing power of the lens is changed to be more positive.

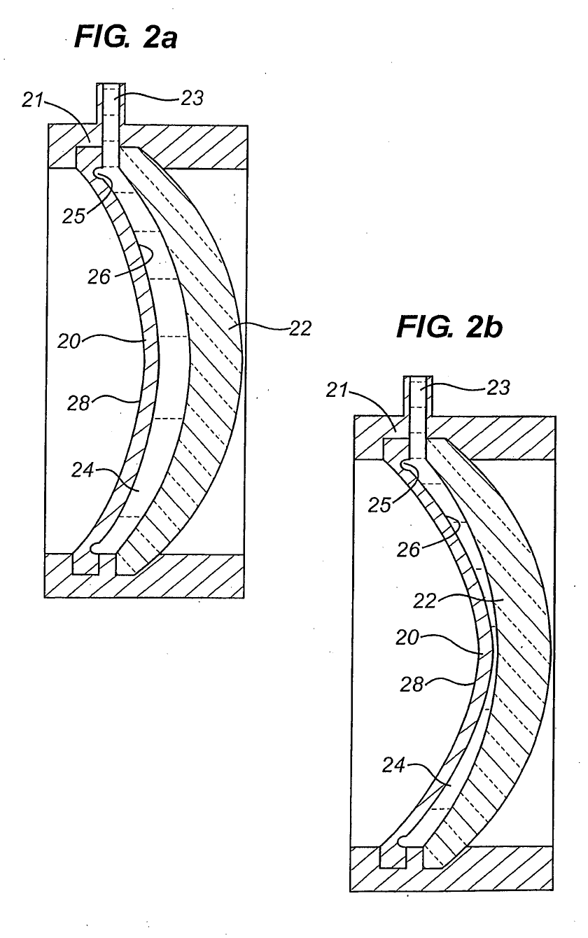

FIGS. 3a to 3c show a lens according to yet another embodiment of the present invention. The lens comprises a rigid piano concave wall 30 and a flexible wall 32 which becomes thinner towards its central region. The planar surface of the wall 30 faces the flexible wall 32. The walls 30, 32 define a cavity for receiving fluid 34. The walls 30, 32 are spaced apart relative to each other and are fitted in annular grooves in the interior surface of the barrel mounting 31. Each of the walls 30, 32 has a flat peripheral edge for engagement with a square notch-type groove in the mounting 31. The flexible wall 32 is provided with two annular grooves 35, one in each surface of the wall. The grooves have a c-shaped cross section and the depth of their bases is such that the distance between the two bases is the same or substantially the same as the thickness of the flexible wall 32 at its centre. Again, while the distance is the same or substantially the same in this embodiment, other distances between the groove base and the other surface 28 may be practised provided the resulting groove functions sufficiently as a hinge. The grooves act as hinges to improve the consistency of the curvature of the flexible wall across its surfaces. The walls 30, 32 are housed in a barrel mounting 31. Whilst a barrel mounting is disclosed for this and other embodiments, it would be apparent to one skilled in the art that other mechanisms for holding together the walls may be practised such as bonding or welding, for example. The fluid 34 is inserted into and removed from the cavity via port 33 which extends through the barrel mounting 31 into the cavity. The port 33 provides for fluid communication between the cavity and a fluid reservoir (not shown). By controlling the volume of fluid 34 in the cavity, the flexible wall 32 is caused to move such that various lens shapes can be formed.

In FIG. 3a, the amount of fluid 34 is controlled so that the flexible wall 32 is positioned such that a first surface 36 closest to the rigid wall 30 is convex and a second surface 38 farthest from the rigid wall 30 is concave.

In FIG. 3b, the amount of fluid 34 is controlled so that the flexible wall 32 is positioned such that the first surface 36 closest to the rigid wall 30 is concave and the second surface 38 farthest from the rigid wall 30 is substantially planar.

In FIG. 3c, the amount of fluid 34 is controlled so that the flexible wall 32 is positioned such that a first surface 36 closest to the rigid wall 30 is concave and a second surface 38 farthest from the rigid wall 30 is convex.

In each of FIGS. 3a to 3c, the volume of fluid 34 between the walls 30, 32 is increased. By changing the amount of fluid 34 in the cavity from the amount shown in FIG. 3a to the amount shown in FIG. 3c, the focusing power of the lens is changed from a negative power to a positive power.

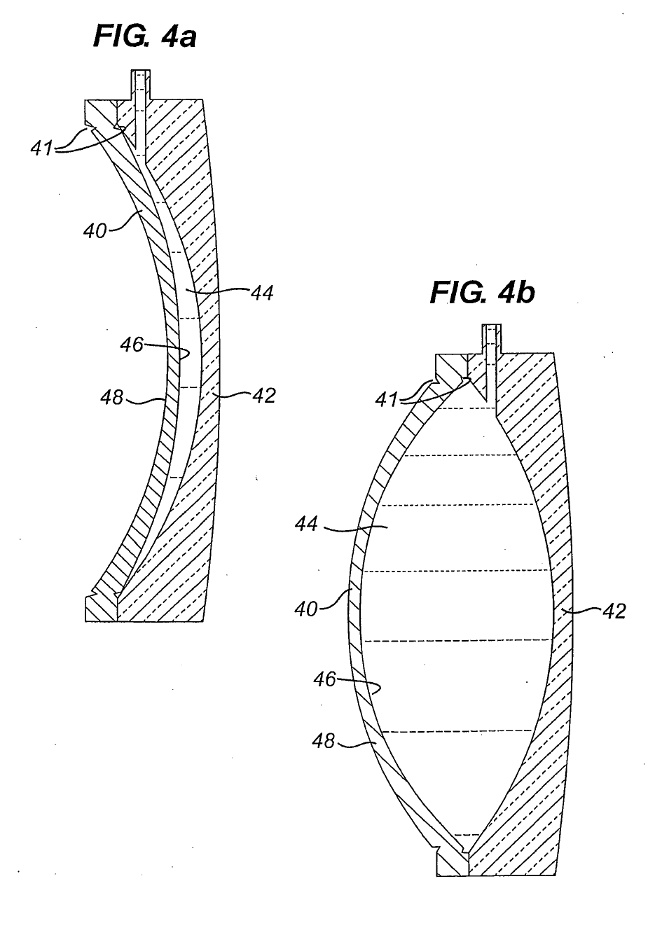

FIGS. 5a to 5d show a lens according to a still further embodiment of the present invention. The lens comprises a piano convex rigid wall 50 and a flexible wall 52 which becomes thinner towards its central region. The walls 50, 52 define a cavity for receiving fluid 54. The flexible wall 52 is provided with two annular grooves 55, one in each surface of the wall. The grooves have a c-shaped cross section and the depth of their bases is such that the distance between the two bases is the same or substantially the same as the thickness of the flexible wall 52 at its centre. Whilst the distances are the same or substantially the same in this embodiment, this is not essential. Other distances may be implemented without departing from the scope and spirit of the invention. The grooves act as hinges to improve the consistency of the curvature of the flexible wall across its surfaces. The walls 60, 62 are spaced apart relative to each other. In this embodiment, the planar surface of the rigid wall 50 faces the flexible wall 52, while the curved surface of the rigid wall 50 faces away from the flexible wall 52. The walls 50, 52 are housed in a barrel mounting 51. In this embodiment, the rigid wall 50 does not have a square peripheral edge, but instead has a curved surface on one side of the wall and a largely planar surface on the other, resulting in a sharp edge. The barrel mounting 51 has a reciprocally formed groove in its internal surface for engagement with the periphery of the rigid wall 50. In this embodiment, the flexible wall 52 has a square peripheral edge again, which keys with a corresponding square notch-type groove in the mounting 51. Whilst a barrel mounting is disclosed for this and other embodiments, it would be apparent to one skilled in the art that other mechanisms for holding together the walls may be practised such as bonding or welding, for example. The fluid 54 is inserted into and removed from the cavity via port 53, which extends through the barrel mounting 51 into the cavity. The port 53 provides for fluid communication between the cavity and a fluid reservoir (not shown). By controlling the volume of fluid 54 in the cavity, the flexible wall 52 is caused to move such that various lens shapes can be formed.

In FIG. 5a, the amount of fluid 54 is controlled so that the flexible wall 52 is positioned such that a first surface 56 closest to the rigid wall 50 is convex and a second surface 58 farthest from the rigid wall 50 is concave.

In FIG. 5b, the amount of fluid 54 is controlled so that the flexible wall 52 is positioned such that the first surface 56 closest to the rigid wall 50 is substantially planar and the second surface 58 farthest from the rigid wall 50 is concave.

In FIG. 5c, the amount of fluid 54 is controlled so that the flexible wall 52 is positioned such that the first surface 56 closest to the rigid wall 50 is concave and the second surface 58 farthest from the rigid wall 50 is substantially planar.

In FIG. 5d, the amount of fluid 54 is controlled so that the flexible wall 52 is positioned such that the first surface 56 closest to the rigid wall 50 is concave and the second surface 58 farthest from the rigid wall 50 is convex.

By changing the amount of fluid 54 in the cavity from the amount shown in FIG. 5a to the amount shown in FIG. 5d, the focusing power of the lens is changed to be more positive.

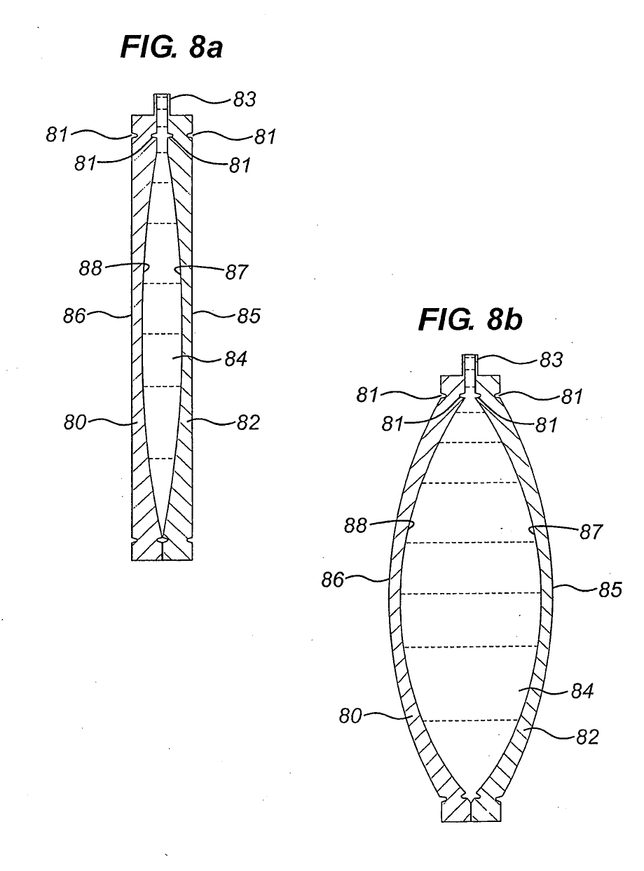

FIGS. 10a to 10c show a lens according to a further embodiment of the present invention. The lens comprises a substantially planar rigid wall 110 and a flexible wall 112, which becomes thinner towards its central region. The walls 110, 112 define a cavity for receiving fluid 114. The walls 110 and 112 are spaced apart in this embodiment. The flexible wall 112 is provided with an annular groove 115 on a first surface 116 thereof. The groove 115 has a v-shaped cross section and the distance between the base of the groove 115 and the other surface 118 of the flexible wall 112 is the same or substantially the same as the thickness of the flexible wall 112 at its centre. Whilst the distances are the same or substantially the same in this embodiment, other distances may be practiced without departing from the scope and spirit of the invention. The walls 110, 112 are housed in a barrel mounting 111. Whilst a barrel mounting is disclosed for this and other embodiments, it would be apparent to one skilled in the art that other mechanisms for holding together the walls may be practised such as bonding or welding, for example. Fluid 114 is inserted into and removed from the cavity via a port 113, which extends through the flexible wall 112. The port 113 provides for fluid communication between the cavity and a fluid reservoir (not shown). By controlling the volume of fluid 114 in the cavity, the flexible wall 112 is caused to move such that various lens shapes can be formed.

For example, in FIG. 10a, the amount of fluid 114 is controlled so that the flexible wall 112 is positioned such that a first surface 116 of that wall 112 closest to the rigid wall 110 is substantially planar and a second surface 118 farthest from the rigid wall 110 is concave.

In FIG. 10b, the amount of fluid 114 is controlled so that the flexible wall 112 is positioned such that its first surface 116 closest to the rigid wall 110 is concave and its second surface 118 farthest from the rigid wall 110 is convex.

In FIG. 10c, the amount of fluid is controlled so that the flexible wall is positioned such that a first surface 116 closest to the rigid wall 110 is concave and a second surface 118 farthest from the rigid wall 110 is convex.

By changing the amount of fluid 114 in the cavity from the amount shown in FIG. 10a to the amount shown in FIG. 10c, the focusing power of the lens is changed to become more positive.

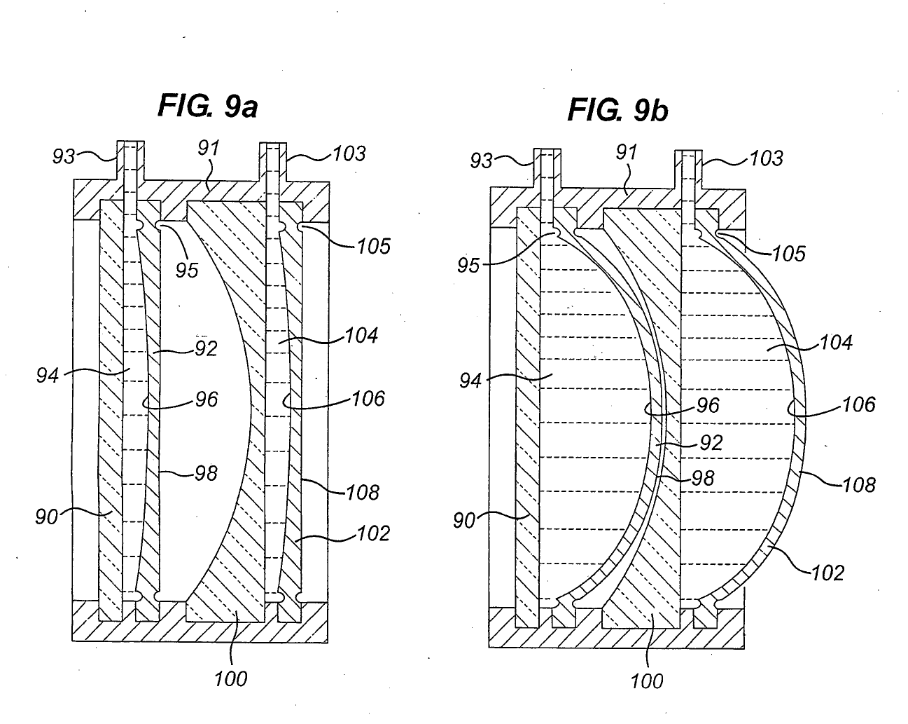

FIGS. 11a to 11c show a lens according to still a further embodiment of the present invention. The lens comprises a substantially planar rigid wall 120 and a flexible wall 122, which becomes thinner towards its central region. The walls 120, 122 define a cavity for receiving fluid 124. The walls 120, 122 are housed in a barrel mounting 121. Whilst a barrel mounting is disclosed for this and other embodiments, it would be apparent to one skilled in the art that other mechanisms for holding together the walls may be practised such as bonding or welding, for example. The fluid 124 is inserted into and removed from the cavity via ports 123 which are equally spaced around the circumference of the lens, as shown in FIGS. 11a and 11c, and which extend through the barrel mounting 121 into the cavity. The ports 123 provide for fluid communication between the cavity and a fluid reservoir 140. By controlling the volume of fluid 124 in the cavity, the flexible wall 122 is caused to move such that various lens shapes can be formed. The lens also comprises an annular groove 130 of v-shaped cross section around the periphery of the flexible wall 122. The groove is formed in a first surface of the flexible wall which is closest to the rigid wall 120. The groove acts as a hinge to improve the consistency of the curvature of the flexible wall across its surface. A blunt v-shaped or a c-shaped cross-section groove may be practiced instead. Further, the flexible wall may have more than one groove 130.

FIG. 15 show a lens according to another embodiment of the present invention. The lens comprises a substantially planar rigid wall 1500 and a flexible wall 1510, which becomes thinner towards its central region. The walls 1500, 1510 define a cavity for receiving fluid. The walls 120, 122 are bonded or welded together, for example, but other mechanisms may be practiced for holding them together. The fluid is inserted into and removed from the cavity via ports 1503 which are equally spaced around the circumference of the lens and which extend into the cavity. The ports 1503 provide for fluid communication between the cavity and a fluid reservoir (not shown). By controlling the volume of fluid in the cavity, the flexible wall 1510 is caused to move such that various lens shapes can be formed. The flexible wall 1510 has two annular grooves 1511 of v-shaped cross section around the periphery of the flexible wall 1510. The groove 1511 in this embodiment are displaced or offset relative to each other on opposite sides of the wall 1510 and may be deeper than is the case where the grooves are positioned opposite each other. Again, the groove 1511 acts as a hinge to improve the consistency of the curvature of the flexible wall 1510 across its surface. A blunt v-shaped or a c-shaped cross-section groove may be practiced instead.

### 8. A Multiple-Element System

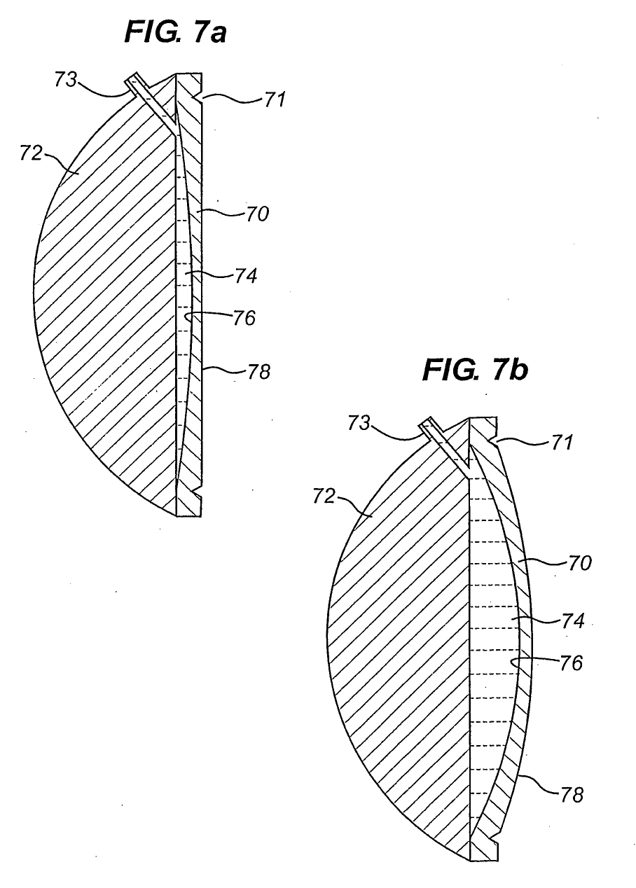

FIGS. 9a and 9b show a multiple-element system including two lenses according to an embodiment of the present invention. The system comprises a first lens according to an embodiment of the present invention including a substantially planar rigid wall 90 and a flexible wall 92 which becomes thinner towards its central region. The walls 90, 92 define a cavity for receiving fluid 94. In this embodiment, the two walls 90, 92 are slightly spaced apart. The flexible wall 92 is provided with two annular grooves 95, one in each surface of the wall. The grooves have a c-shaped cross section and the depth of their bases is such that the distance between the two bases is the same or substantially the same as the thickness of the flexible wall 92 at its centre. Again, whilst the distances are the same or substantially the same in this embodiment, this is not essential. Different distances may be practiced. The grooves act as hinges to improve the consistency of the curvature of the flexible wall across its surfaces. The walls 90, 92 are housed in a barrel mounting 91 in mating engagement of their square peripheral edges with the square notch-type grooves formed in the interior surface of the barrel mounting 91. Whilst a barrel mounting is disclosed for this and other embodiments, it would be apparent to one skilled in the art that other mechanisms for holding together the walls may be practised such as bonding or welding, for example. The fluid 94 is inserted into and removed from the cavity via a port 93 which extends through the barrel mounting 91 into the cavity. The port 93 provides for fluid communication between the cavity and a fluid reservoir (not shown). By controlling the volume of fluid 94 in the cavity, the flexible wall 92 is caused to move such that various lens shapes can be formed.

In FIG. 9a, the amount of fluid 94 is controlled so that the flexible wall 92 is positioned such that a first surface 96 of that wall 92 closest to the rigid wall 90 is concave and a second surface 98 farthest from the rigid wall 90 is substantially planar.

The system further comprises a second lens according to an embodiment of the present invention including a piano concave rigid wall 100 and a flexible wall 102 which becomes thinner towards its central region. The walls 100, 102 define a cavity for receiving fluid 104. The curved surface of the wall 100 faces the flexible wall 92 and away from the flexible wall 102. The planar surface of the rigid wall 100 faces the flexible wall 102. The flexible wall 102 is provided with two annular grooves 105, one in each surface of the wall. The grooves have a c-shaped cross section and the depth of their bases is such that the distance between the two bases is the same or substantially the same as the thickness of the flexible wall 102 at its centre. Whilst the distances are the same or substantially the same in this embodiment, this is not an essential feature of the present invention. The grooves act as hinges to improve the consistency of the curvature of the flexible wall across its surfaces. The walls 100, 102 are housed in barrel mounting 91. The fluid 104 is inserted into and removed from the cavity via a port 103 which extends through the barrel mounting 91 into the cavity. The port 103 provides for fluid communication between the cavity and a fluid reservoir (not shown). By controlling the volume of fluid 104 in the cavity, the flexible wall 102 is caused to move such that various lens shapes can be formed.

In FIG. 9a, the amount of fluid 104 is controlled so that the flexible wall 102 is positioned such that a first surface 106 of that wall 102 closest to the rigid wall 100 is concave and a second surface 108 farthest from the rigid wall 100 is substantially planar.

In FIG. 9b, the amount of fluid 94 is controlled so that the flexible wall 92 is positioned such that its first surface 96 closest to the rigid wall 90 is concave and its second surface 98 farthest from the rigid wall 90 is convex. The amount of fluid 104 is controlled so that the flexible wall 102 is positioned such that its first surface 106 closest to the rigid wall 100 is concave and its second surface 108 farthest from the rigid wall 100 is convex.

By changing the amount of fluid 94, 104 in the cavities from the amount shown in FIG. 9a to the amount shown in FIG. 9b, the overall focusing power of the multiple-element system becomes more positive.

While specific combinations of lenses are shown in FIG. 9, one skilled in the art will readily apprehend in the light of this disclosure that other combinations of lenses in accordance with the foregoing embodiments may be practiced.

### 9. Lens Applications Including Cameras and Lighting Systems

Numerous applications exist for the use of lenses and multiple-element systems in accordance with the embodiments of the invention. For example, two such applications are cameras and lighting systems.

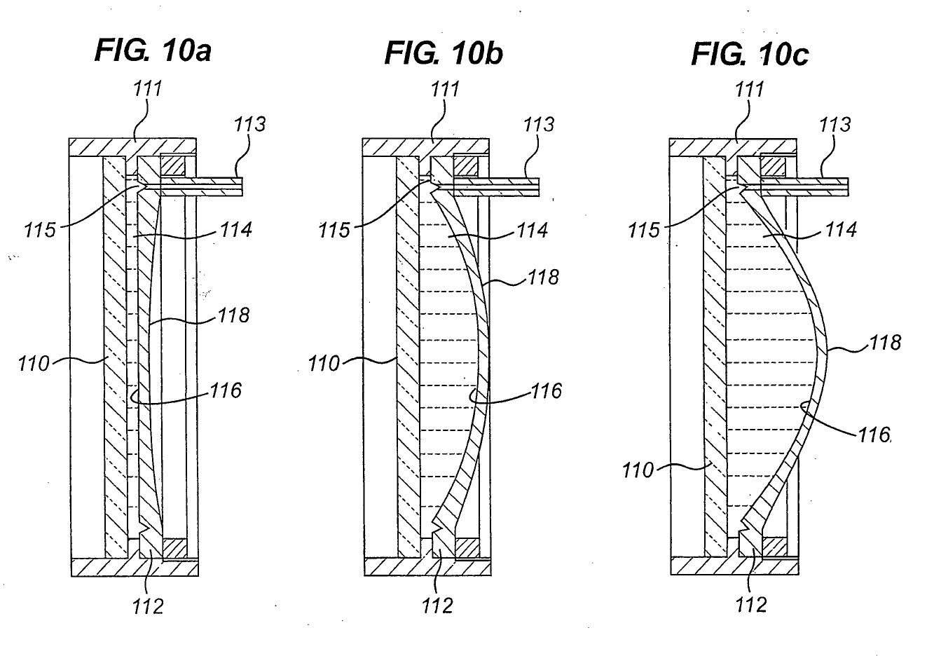

FIG. 12 shows a camera 200 including a lens 210 according to an embodiment of the present invention. A lens in accordance with any of the foregoing embodiments may be implemented in the lens generally depicted and identified by reference numeral 210. The camera comprises an image capture system, which may use film in an analog device or may be electronics in a digital camera.

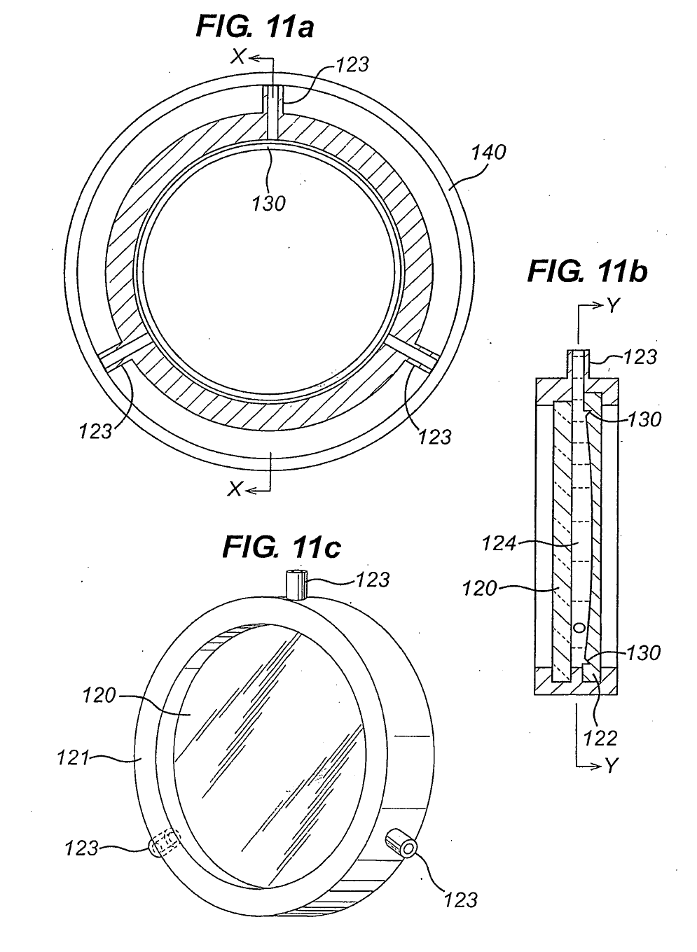

FIG. 13 shows a lighting system 300 including a lens 310 according to an embodiment of the present invention. A lens in accordance with any of the foregoing embodiments may be implemented in the lens generally depicted and identified by reference numeral 310. The lighting system also comprises a lighting element for radiating light.

The wall(s) in accordance with each of the foregoing embodiments may be coated with a standard lens coating, such as an anti-reflective coating, an anti-dust coating, or anti-UV coating, for example. The walls would be made of materials capable of accepting a coating such as polycarbonate, polymers and polyesters.

A small number of embodiments of the invention regarding lenses and methods of manufacturing lenses and of manufacturing a flexible wall for a lens have been described. In the light of the foregoing disclosure, it will be apparent to those skilled in the art that various modifications and/or substitutions may be made to those embodiments without departing from the scope and spirit of the invention.

1. A lens comprising:
a first flexible wall having a first groove formed therein towards a perimeter of said first wall for a hinge; and
a second wall, said first wall and said second wall defining a cavity for receiving fluid such that various lens shapes can be formed by controlling the volume of fluid within the cavity.

2. A lens according to claim 1, wherein said first wall is defined by a first surface and a second surface, and the groove is formed in the first surface of said first wall.

3. A lens according to claim 2, wherein the first surface of said first wall is a concave surface and the second surface of said first wall is a planar surface.

4. A lens according to claim 2, wherein both the first surface and second surface of said first wall are concave surfaces.

5. A lens according to claim 2, further comprising a second groove towards the perimeter of said first wall, the second groove being formed in the second surface of said first wall.

6. A lens according to claim 1, wherein the first groove has a v-shaped cross-section.

7. A lens according to claim 1, wherein the first groove has a c-shaped cross-section.

8. A lens according to claim 1, wherein the groove is annular.

9. A lens according to claim 2, wherein said first wall becomes progressively thinner towards its central region and the depth of the groove is such that the least distance between an apex or base of the groove and the second surface is substantially the same as the thickness of said first wall at its central region.

10. A lens according to claim 1, wherein said first wall and said second wall are housed in a barrel mounting.

11. A lens according to claim 1, wherein said first wall and said second wall are bonded, welded or fused together.

12. A lens according to claim 1, wherein the second wall is formed from a rigid material and is defined by a first surface and a second surface, wherein at least one of the first and second surfaces is a convex surface.

13. A lens according to claim 1, wherein the second wall is formed from a rigid material and is defined by a first surface and a second surface substantially parallel to the first surface.

14. A lens according to claim 1, wherein the second wall is formed from polycarbonate or glass.

15. A lens according to claim 1, wherein the second wall is flexible.

16. A lens according to claim 15 wherein the second wall becomes progressively thinner towards its central region.

17. A lens according to claim 1, further comprising at least one port into the cavity through which fluid can flow.

18. A lens according to claim 17, comprising a plurality of ports into the cavity through which fluid can flow, wherein the plurality of ports are spaced around a circumference of said lens.

19. A lens according to claim 18, wherein the plurality of ports are equally spaced around the circumference of the lens.

20. A lens according claim 17, 18, or 19, wherein fluid can flow both into and out of the cavity through said at least one port.

21. A lens according to claim 17, wherein said at least one port is formed through the second wall.

22. A lens according to claim 17, wherein the at least one port comprises a tube bonded to the second wall.

23. A lens according to claim 22, wherein the tube comprises a polythene or silicone tube.

24. A lens according to claim 1, wherein the fluid comprises one of an oil, a glycerine, and a water based product.

25. A lens according to claim 1, wherein each flexible wall is resilient.

26. A lens according to claim 1, wherein each flexible wall is formed of a component comprising. a stretchable, pliable, variform disc of synthetic homogenous material of optical clarity that is capable of variable dilatation.

27. A lens according to claim 1, wherein each flexible wall is formed from one of a silicone rubber, a plastics material, an acrylic material, a flexible polycarbonate, an epoxy resin and a polyester.

28. A lens according to claim 1, further comprising a fluid reservoir in fluid communication with the cavity.

29. A lens according to claim 28, wherein the lens forms a closed circuit, discreet, sealed package in which the reservoir and cavity are permanently connected via at least one port or a continuous circular channel formed by a groove.

30. A lens according to claim 28, further comprising a pump, a piston, a plunger, a conventional focus barrel, or any force-provider applied to the outside of the reservoir, for expelling fluid from the reservoir or withdrawing fluid from the lens cavity.

31. A camera comprising:
a lens comprising:
a first flexible wall having a first groove formed therein towards a perimeter of said first wall for a hinge; and
a second wall, said first wall and said second wall defining a cavity for receiving fluid such that various lens shapes can be formed by controlling the volume of fluid within the cavity.

32. A lighting system comprising:
a lighting element; and
a lens comprising:
a first flexible wall having a first groove formed therein towards a perimeter of said first wall for a hinge; and
a second wall, said first wall and said second wall defining a cavity for receiving fluid such that various lens shapes can be formed by controlling the volume of fluid within the cavity.

33. A method of manufacturing a flexible wall for a lens having a first groove formed therein towards a perimeter of said flexible wall for a hinge, said flexible wall for at least partly defining a cavity for receiving fluid such that various lens shapes can be formed by controlling the volume of fluid within the cavity, said method comprising the step of moulding the flexible wall against a female profile glass, acrylic or silica optics, or plastics mould.

34. A method of manufacturing a flexible wall for a lens having a first groove formed therein towards a perimeter of said flexible wall for a hinge, said flexible wall for at least partly defining a cavity for receiving fluid such that various lens shapes can be formed by controlling the volume of fluid within the cavity, said method comprising the step of spinning, centrifuging, introducing gas, bubble or using flow, pour, draw vacuum technology.

35. A lens, comprising:
a flexible wall made of a material suitable for use in an optical lens that becomes progressively thinner towards its central region, said flexible wall having at least one groove formed therein towards the periphery of said flexible wall; and
another wall made of a material suitable for use in an optical lens, said first wall and said second wall configured in parallel and defining a cavity for receiving fluid, various lens shapes capable of being formed by controlling the volume of fluid between said walls.

36. The lens according to claim 35, wherein said other wall is flexible.

37. The lens according to claim 36, wherein said other flexible wall becomes progressively thinner towards its central region.

38. The lens according to claim 35, wherein said second wall is rigid.

39. The lens according to claim 37, wherein said walls are bonded, welded, or fused together at the periphery of each wall forming a seal therebetween.

40. The lens according to claim 37, further comprising a barrel mounting housing said walls or an annular clamp holding together said walls.

41. The lens according to claim 35, comprising at least one port formed between said walls or through one of said walls for communication of fluid between said walls.

42. The lens according to claim 41, further comprising a fluid reservoir coupled to said at least one port.

43. The lens according to claim 35, further comprising a fluid that is transparent to radiation being transmitted by said lens and has suitable thermal stability.
